(19) United States
(12) Patent Application Publication
(10) Pub. No.: US 2025/0071808 A1
(43) Pub. Date: Feb. 27, 2025

(54) Multiple Registration Access Security

(71) Applicant: Ofinno, LLC, Reston, VA (US)

(72) Inventors: Henrik Andreas Normann, Malmö (SE); SungDuck Chun, Fairfax, VA (US); Esmael Hejazi Dinan, McLean, VA (US); Peyman Talebi Fard, Vienna, VA (US); Jian Xu, McLean, VA (US); Kyungmin Park, Vienna, VA (US); Taehun Kim, Fairfax, VA (US)

(73) Assignee: Ofinno, LLC, Reston, VA (US)

(21) Appl. No.: 18/812,447

(22) Filed: Aug. 22, 2024

Related U.S. Application Data
(60) Provisional application No. 63/534,694, filed on Aug. 25, 2023.

(51) Int. Cl. H04W 74/08; H04W 60/00

(52) U.S. Cl. CPC H04W 74/08; H04W 60/00

(57) ABSTRACT

An AMF receives, from a wireless device, a first registration request message for a first access path of an access type via a first access node. The AMF determines a common security context for the wireless device and sends, to the first access node, a first access stratum (AS) key, wherein the first AS key is based on a first value associated with the first access path and the common security context. The AMF receives, from the wireless device a second registration request message for a second access path of the access type via a second access node, and sends, to the second access node, a second AS key, wherein the second AS key is based on a second value associated with the second access path and the common security context.

### CROSS-REFERENCE TO RELATED APPLICATIONS

This application claims the benefit of U.S. Provisional Application No. 63/534,694, filed Aug. 25, 2023, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

FIG. 32 is a diagram of an aspect of an example embodiment of the present disclosure.

FIG. 33 is a diagram of an aspect of an example embodiment of the present disclosure.

FIG. 34 is a diagram of an aspect of an example embodiment of the present disclosure.

FIG. 35 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

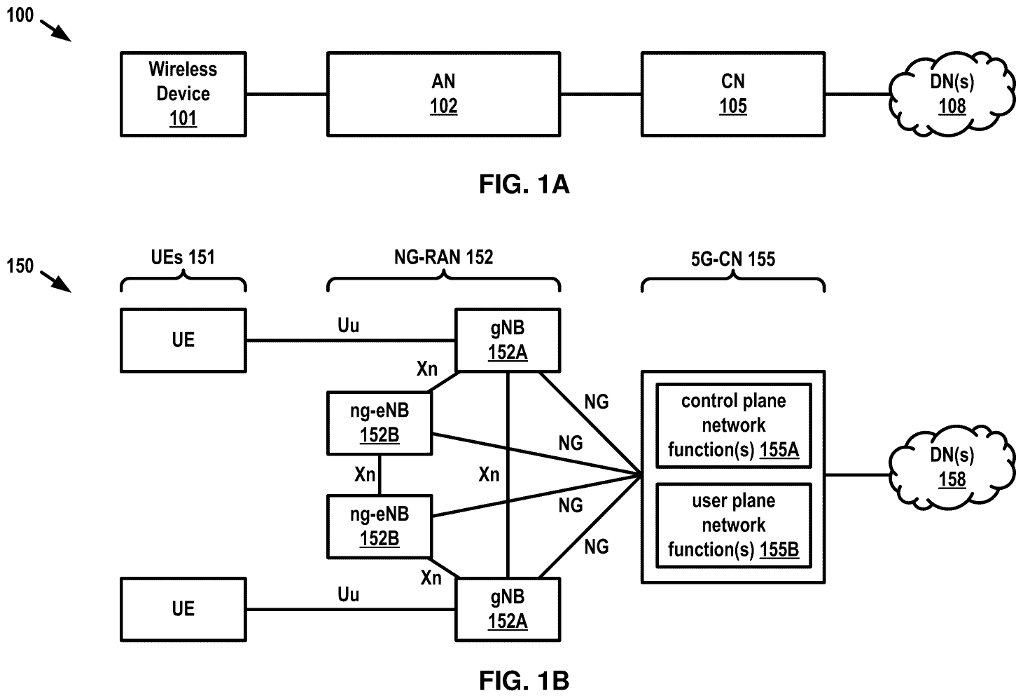

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

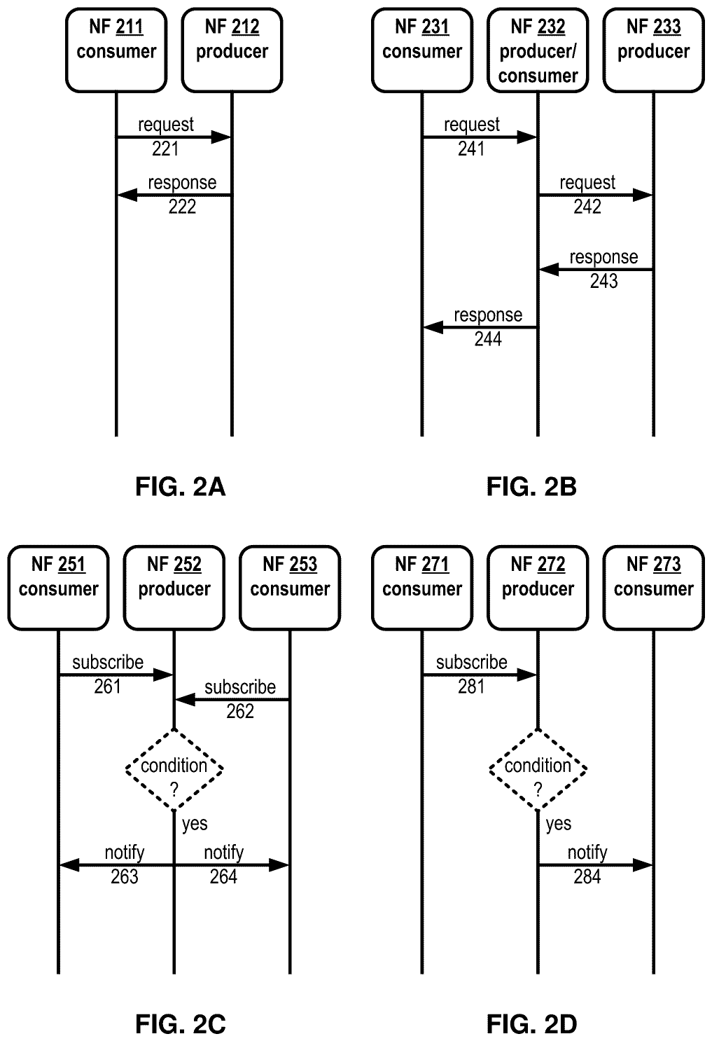

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

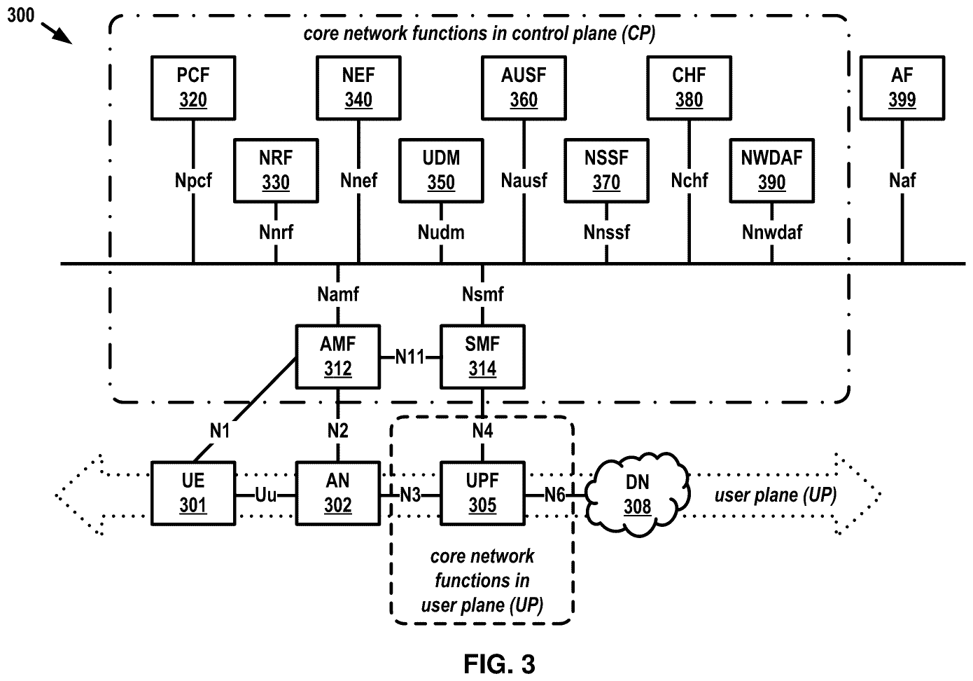

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

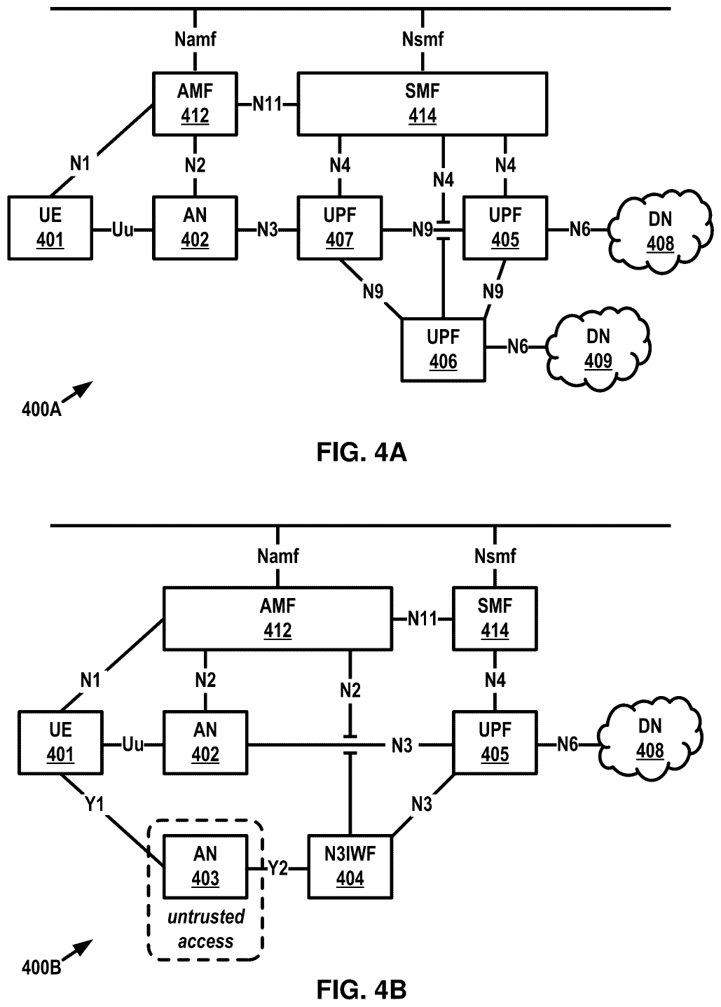

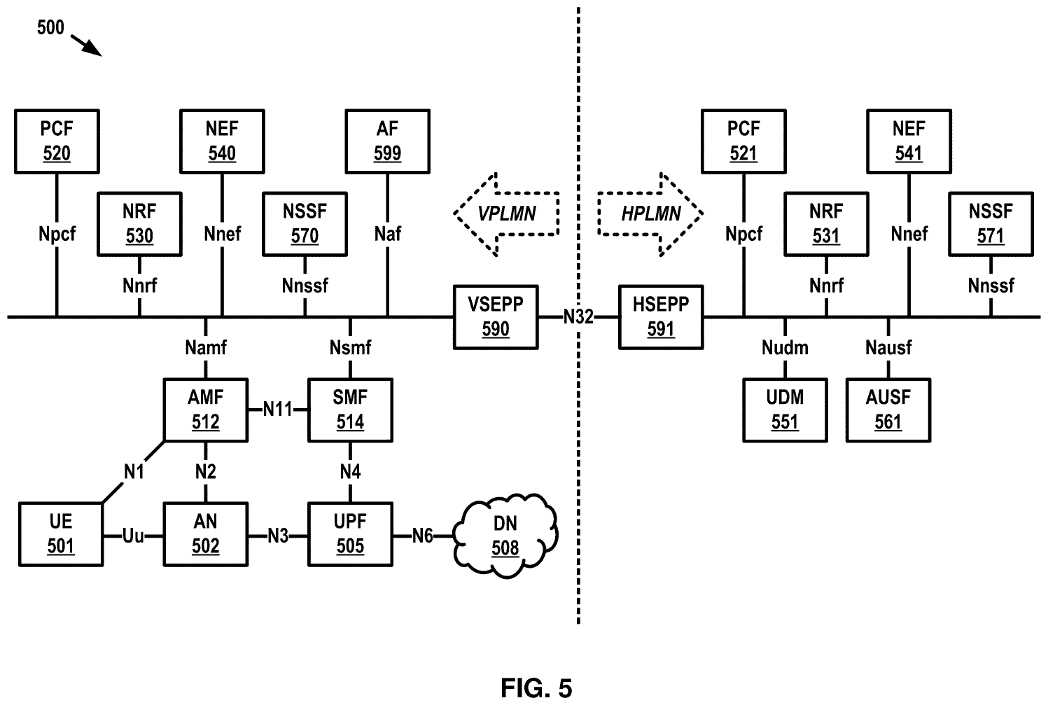

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1. UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface.

The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

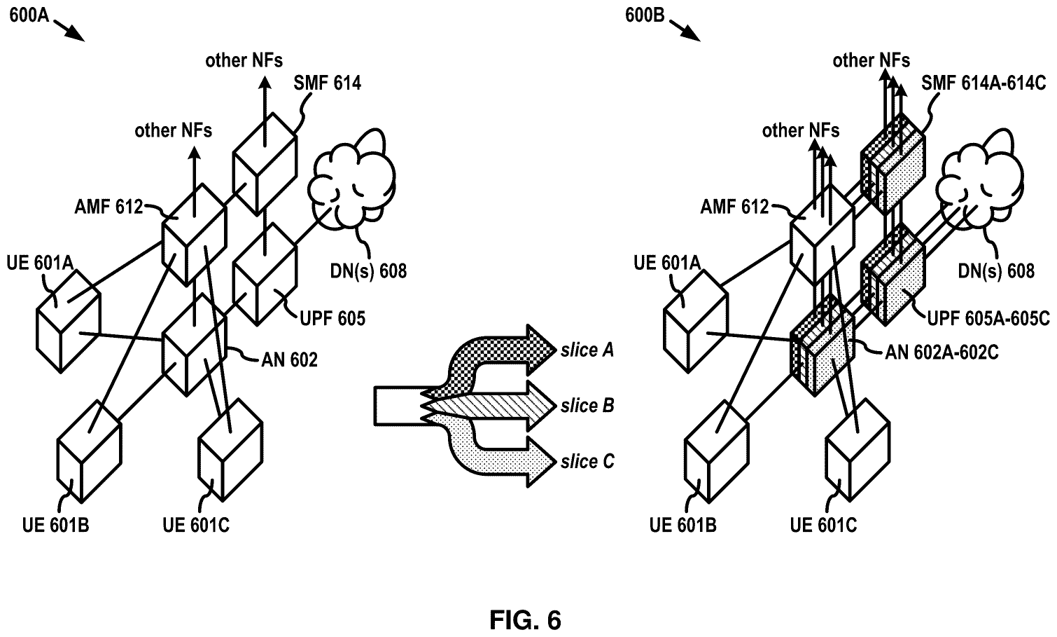

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

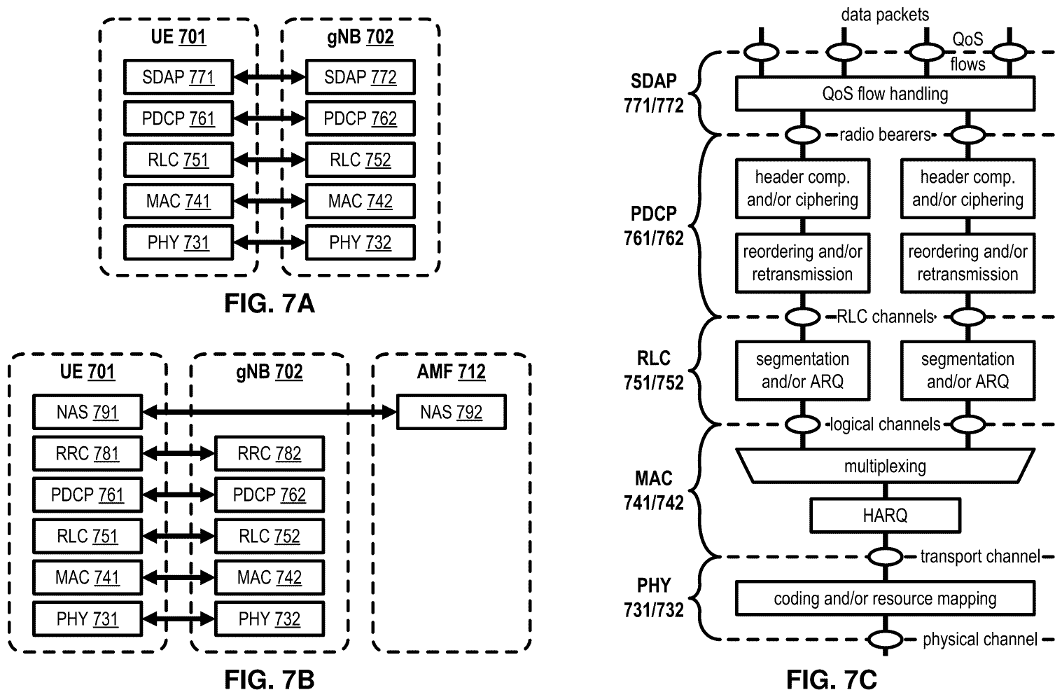

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

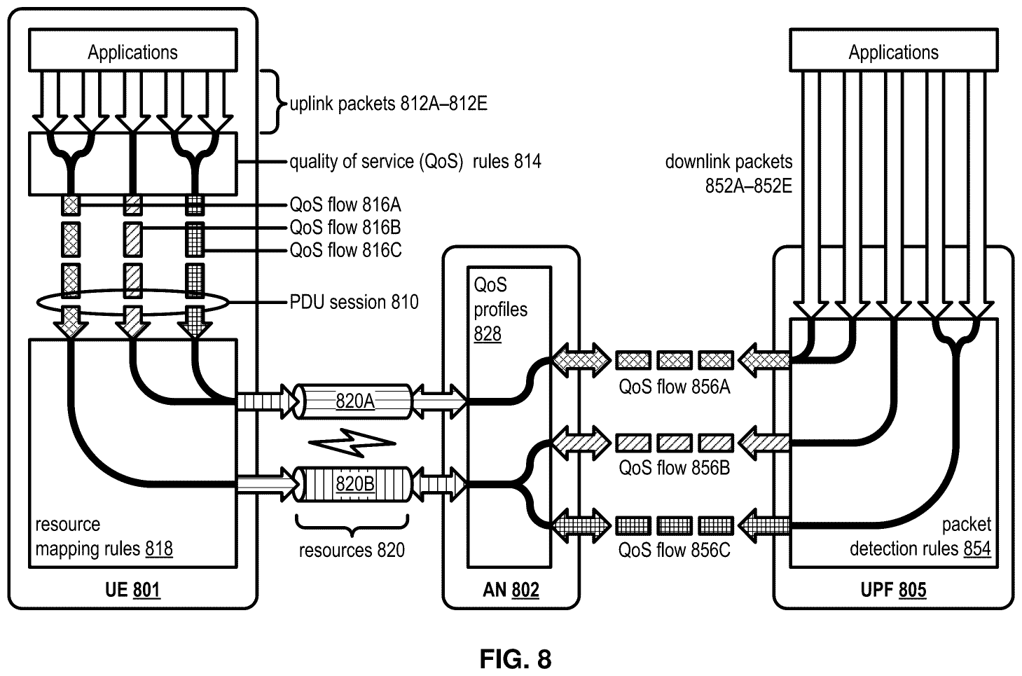

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5Q1 which have one-to-one mapping to a standardized combination of 5G QoS characteristics per well-known services. The 5QI may be a dynamically assigned 5QI which the standardized 5Q1 values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

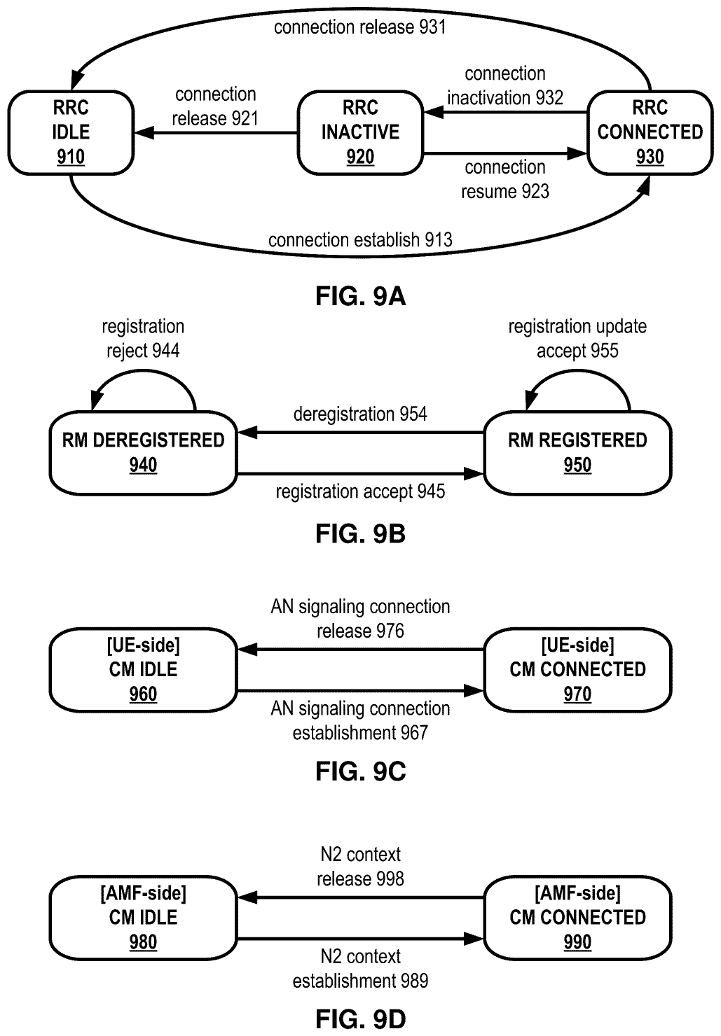

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

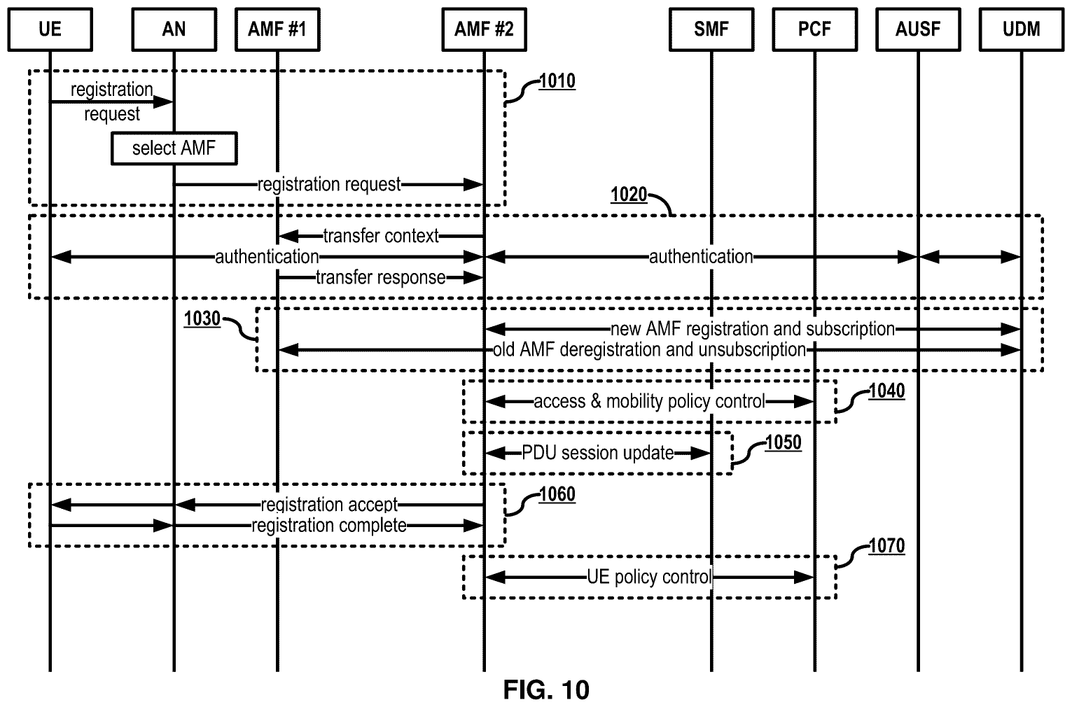

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

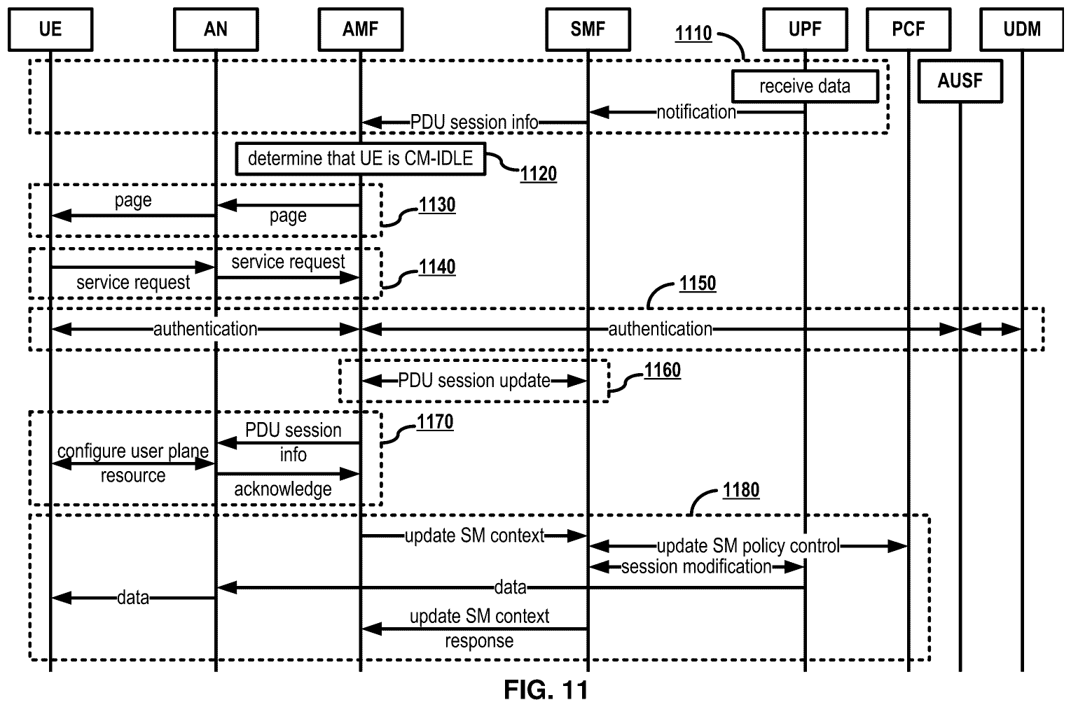

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

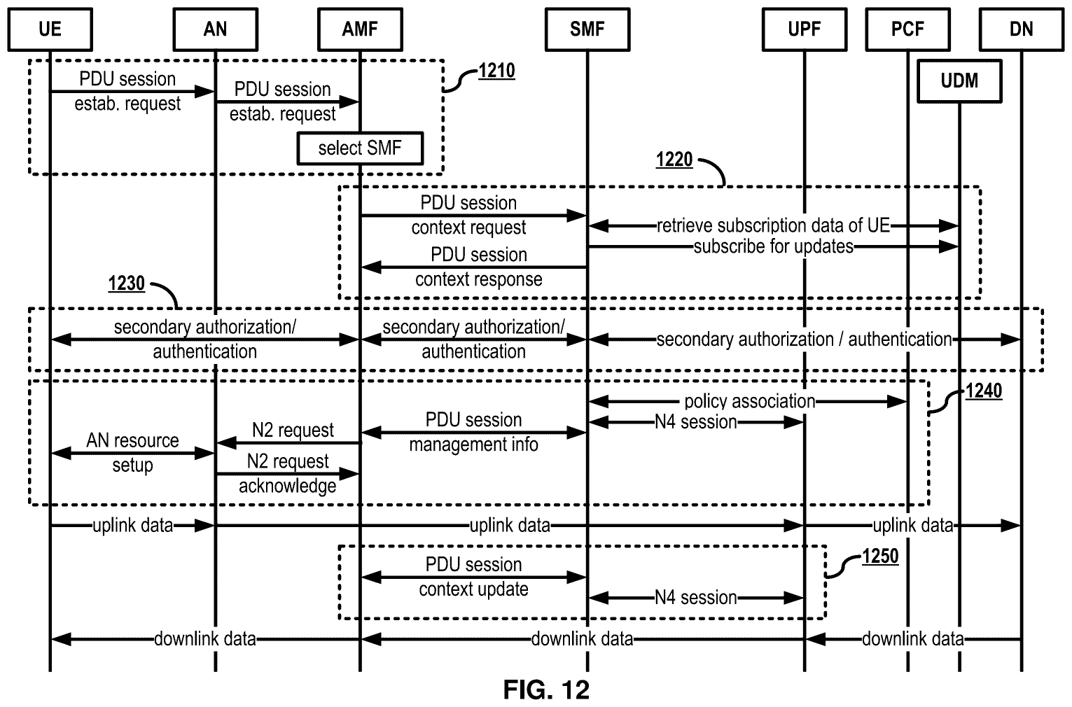

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

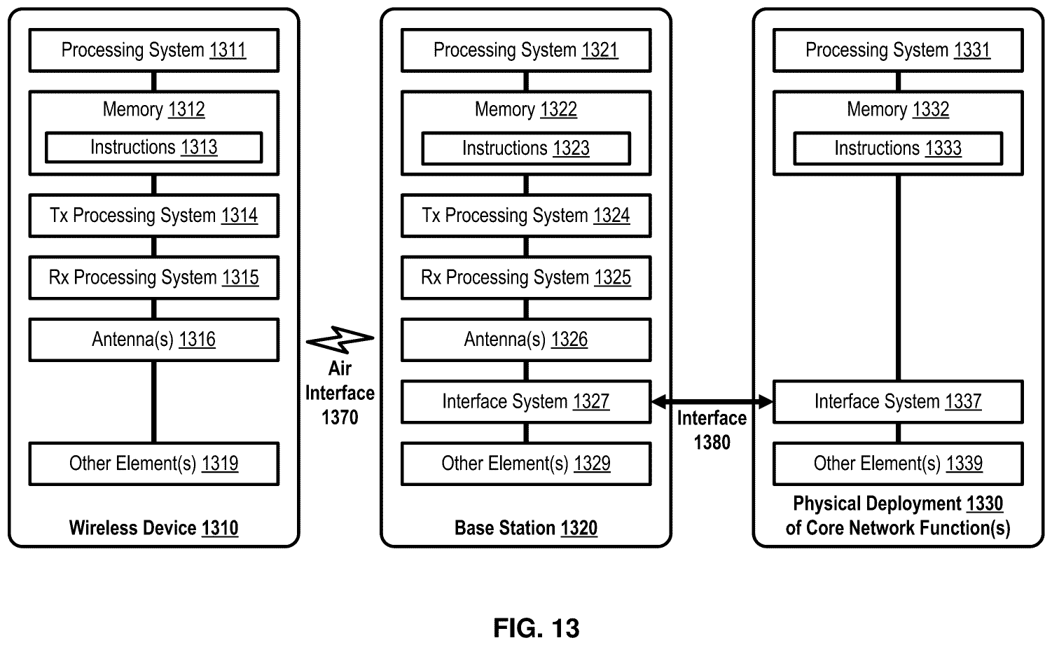

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

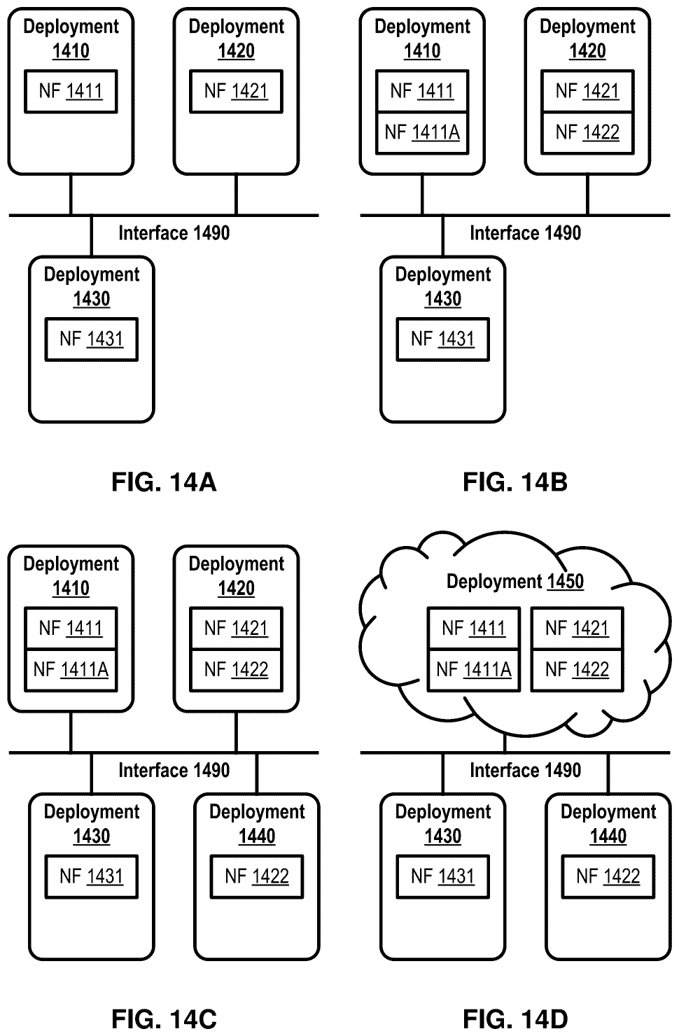

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AEs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

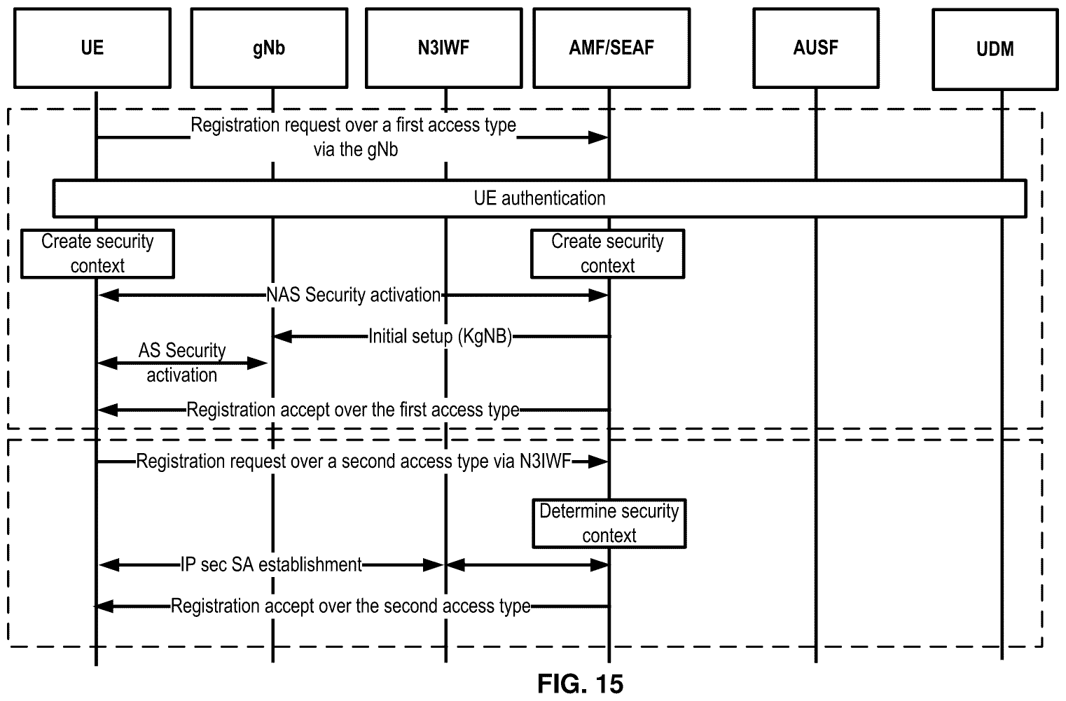

FIG. 15 illustrates an example of how a UE in existing technologies may gain access to a 5G core (5GC) via two different access types.

In an example, the UE may send a first registration request message to an AMF via a first access type. In an example the first registration request message may be a NAS message. For example, the first registration request message may comprise at least one of an identifier, key set identifier in 5G (ngKSI) and/or the like. For example, the identifier may be at least one of a subscriber concealed identifier (SUCI), a 5G global unique temporary identifier (5G-GUTI), and/or the like. In an example, the first registration request message may be an initial NAS message. In an example, the UE may send the first registration request message via a gNB.

In an example, in response to receiving the first registration request message, the AMF may determine to authenticate the UE (UE authentication). In an example, the determining may be based on if the AMF has any security context available in local storage, based on if the registration request comprises a SUCI, based on an operator policy and/or the like. In an example, the absence of a valid security context in the AMF's local storage may result in the AMF running authentication. For example, a valid security context may refer to a security context currently in use by the AMF and the UE.

In an example, the authentication of the UE may refer to run/perform primary authentication. In an example, the primary authentication may be based on 5G-authentication and key agreement (5G-AKA) or Extensible Authentication Protocol-Authentication and Key Agreement′, (EAP-AKA′), for a 5G network and for standalone non-public networks (SNPNs) the primary authentication may additionally be based on key generating extensible authentication protocol (EAP) methods. An example of a key generating EAP method may be extensible authentication protocol-transport layer security (EAP-TLS).

In an example, the AMF may determine to run the authentication. The AMF may send a Nausf_UEAuthentication_Authenticate request message comprising the SUCI or a SUPI and a serving network name (SN-name) to an AUSF. In an example, a security anchor function (SEAF) may send the Nausf_UEAuthentication_Authenticate request message to the AUSF.

In an example, the AUSF may send a Nudm_UEAuthentication get request message to a UDM. In an example, the Nudm_UEAuthentication get request message may comprise the SUCI, the SUPI, the SN-name, and/or the like. In an example, the sending may be in response to (based on) receiving the Nausf_UEAuthentication_Authenticate request message.

In an example, the UDM may receive the Nudm_UEAuthentication get request message from the AUSF. In an example, the UDM may de-conceal the SUCI. For example, de-conceal may refer to gain the SUPI from the SUCI. In an example, the de-concealing may be performed by a UDM service. In an example, the UDM service may be a subscription identifier de-concealing function (SIDF).

In an example, the UDM or an authentication credential repository and processing function (ARPF) may select an authentication method. For example, the authentication method may be 5G-AKA, EAP-AKA′, EAP-TLS and/or the like. In an example, the selection of authentication method may be in response to (based on) receiving determining the SUPI.

In an example, the ARPF may generate an authentication vector to be used during the authentication. In an example, the generation of the authentication vector may be in response to selecting an authentication method.

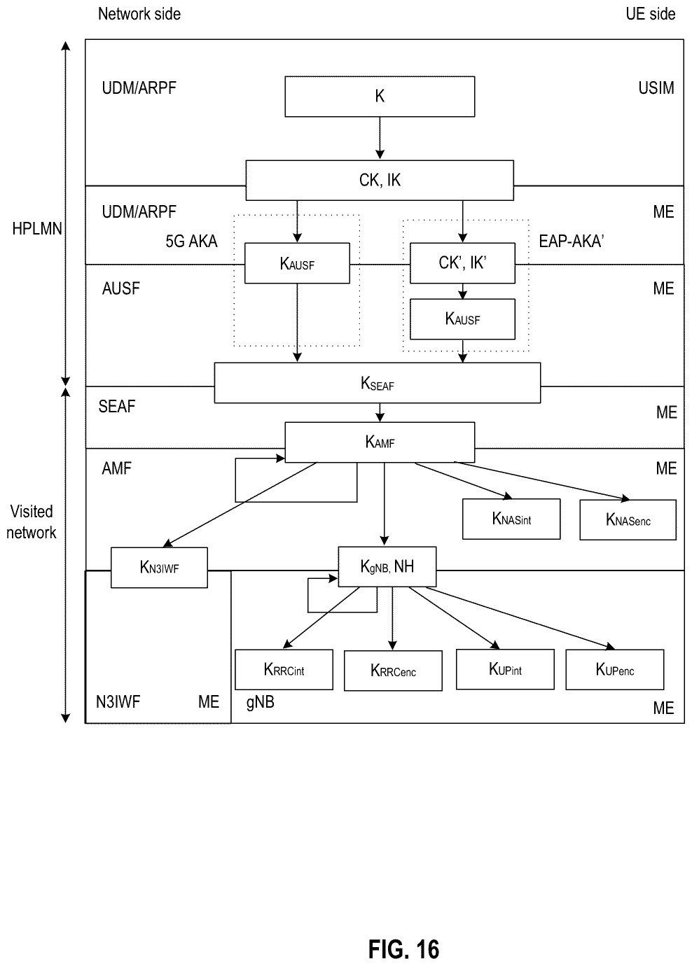

In an example, in response to running a successful primary authentication the AUSF and the UE may establish a key K_{AUSF}. The AUSF and the UE may derive a key K_{SEAF}, based on at least the K_{AUSF}. In an example, the AUSF may send the K_{SEAF} to the SEAF. In an example, the SEAF and the UE may derive a K_{AMF} In an example, the SEAF may send the K_{AMF} to the AMF. In an example, a mobile equipment part of the UE may derive the K_{AUSF}, the K_{SEAF}, the K_{AMF} and/or the like. FIG. 16 may depict an example of a 5G key hierarchy. Reverting back to FIG. 15.

In an example, the AMF and the UE may create a security context. In an example, the creation of the security context may be in response to the AMF receiving the K_{AMF} from the SEAF. For example, the security context may comprise at least one of a key, NAS connection identifier, NAS COUNT values and/or the like. For example, the key may be at least one of the K_{AMF}, a K_{NASint}, a K_{NAsenc} and/or the like. For example, the NAS connection identifier may be a value associated with the first access type. In an example, the access type may comprise (or be associated with) one or more radio access technology (RAT) types. For example, the NAS COUNT values may be at least one of NAS uplink COUNT, NAS downlink COUNT and/or the like.

In an example the security context may refer to a 5G security context, a 5G NAS security context, a full 5G NAS security context, common NAS security context, partial native 5GC NAS security context and/or the like.

In an example embodiment, in response to a successful primary authentication, the AMF may determine to perform a NAS security activation for a first access type. In an example, the NAS security activation may refer to a procedure that starts integrity protection and/or encryption over the first access type. For example, the security activation may refer to a NAS security mode command (SMC) procedure. For example, the NAS SMC procedure may be a roundtrip of messages exchanged between the UE and the AMF. For example, the roundtrip of messages may comprise a NAS security mode command message and a NAS security mode command complete message and/or the like. In an example, the NAS COUNT values for the access type may be set to 0 in response to completing an authentication successfully. In an example, the AMF and UE may derive K_{NASint} and K_{NASenc} during the NAS SMC procedure. In an example, the AMF may start the NAS SMC procedure by sending an integrity protected NAS message to the UE. For example, the integrity protected NAS message may comprise at least one of ngKSI, UE security capabilities, request initial NAS message flag, NAS message authentication code (MAC) and/or the like. In an example, the UE may in response to receiving the integrity protected NAS message send an encrypted and integrity protected NAS message to the AMF.

In an example, in response to completing the security activation, the UE and the AMF may have a common NAS security context available to use for integrity protection and encryption of NAS messages.

In an example, the AMF may send a K_{gNB} to the gNB. For example, the KgNB may be a key used to protect traffic at an AS layer.

In an example, the gNB may perform AS security mode command (SMC) procedure with the UE. In an example, in response to completing the AS SMC procedure the gNB and the UE may have a plurality of keys to protect traffic at the AS layer. For example, the keys may be a K_{RRCnt}, a K_{RRCenc} and/or the like. For example, the AS SMC procedure may be used by the gNB, a ng-eNB and/or the like.

In an example, the UE may receive a first registration accept message over the first access type. For example, the first registration accept message may comprise at least a 5G-GUTI. In an example, in response to receiving the first registration accept message, the UE may send a second registration request message comprising at least the 5G-GUTI over a second access type e.g., non-3GPP access.

In response to receiving the second registration request message, the AMF may determine to authenticate the UE (perform/run primary authentication). For example, the determining may be based on at least one of, on the AMF not having a valid security context available locally for the UE associated with the 5G-GUTI received in the second registration request, based on operator policy, unsuccessful verification of the integrity of the second registration request message and/or the like.

In an example the AMF may determine to skip authentication for the UE. For example, the determining may be based on the AMF having a valid security context available locally for the UE associated with the 5G-GUTI received in the second registration request, successful verification of the integrity of the second registration request message and/or the like.

In an example, the AMF may in response to receiving the second registration request message, determine a security context. In an example, the determining may be based on the AMF having a valid security context available locally for the UE associated with the 5G-GUTI received in the second registration request message and successful integrity verification of the integrity of the second registration request message. For example, the integrity verification may be based on at least a NAS uplink COUNT value associated with non-3GPP access. In an example, an internet protocol security (IPsec) security association (SA) may be established between the UE and the N3IWF. In an example, the UE may receive a second registration accept message over the second access type.

FIG. 16 may depict an example of a 5G key hierarchy. In an example, a primary authentication may be based on 5G-AKA, EAP-AKA′, EAP-TLS and/or the like. In an example, a cipher key (CK) and an integrity key (IK) are derived from a secret K shared by a UE and a network side. For example, the secret K may reside on a universal subscriber identity module (USIM) in the UE. On the network side, the secret K may reside in a UDR or an ARPF. For example, the ARPF may be a functional element of the UDM.

If the primary authentication is successful and based on 5G-AKA a key K_{AUSF} may be derived by the UE and the network side. If the primary authentication is successful and based on EAP-AKA′ the CK and the IK may be replaced with a CK′ and an IK′. For example, in EAP-AKA′ the key K_{AUSF} may be derived by the UE and the network side based on the CK′ and the IK′.

In an example, the network side and the UE may derive a key K_{SEAF}. In an example, the network side may send the key K_{SEAF} to a serving network. For example, the serving network may be a HPLMN or a VPLMN. In an example, the UE and the network side may derive a key K_{AMF} based on the key K_{SEAF}.

In an example, the UE and the network side may derive a key K_{NASint} and a key K_{NAsenc}. For example, the key K_{NASint} may be used for integrity protection of NAS messages. For example, the key K NASenc may be used for ciphering of NAS messages. For example, the key K_{NASenc} and the key K_{NASint} may be based on the key K_{AMF}.

In an example, the UE and the network side may derive a key K_{gNB} and/or a key next hop parameter (NH). In an example, the network side may send the key K_{gNB} and/or the key NH to a base station. For example, the key K_{gNB} and the key NH may be based on the key K_{AMF}.

In an example, the UE and the network side may derive keys for protection of data at an access stratum layer. In an example, the UE and the network side may derive a key K_{RRCint}, a key K_{RRCenc}, a key K_{UPint}, a key K_{UPenc} and/or the like. For example, the key K_{RRCint} may be used for integrity protection of RRC traffic. For example, the key K_{RRCenc} may be used for ciphering of RRC traffic. For example, the key K_{UPint} may be used for integrity protection of UP traffic. For example, the key K_{RRCenc} may be used for ciphering of UP data.

In an example the UE and the network side may derive a key K_{N3IWF}. For example, the key K_{N3IWF} may be used to protect traffic over non-3GPP access.

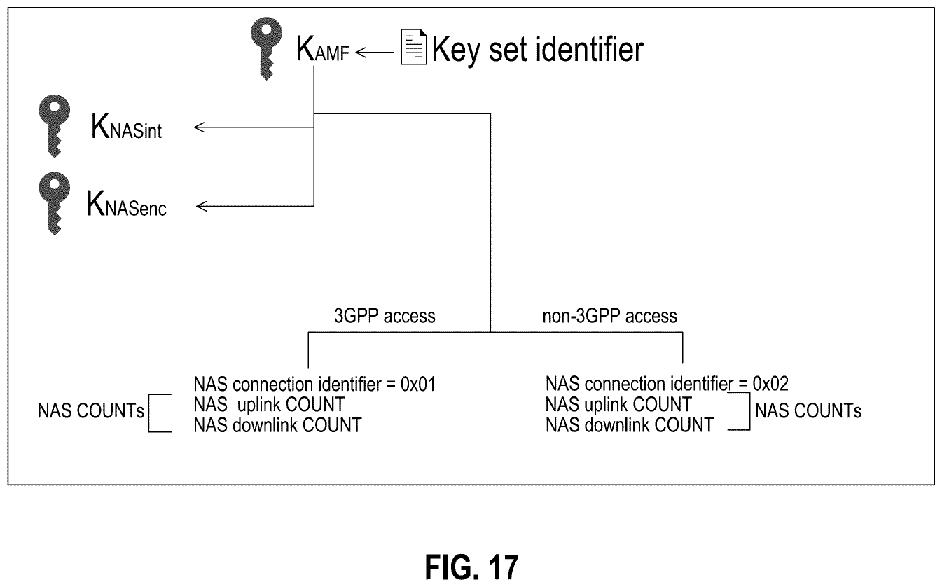

FIG. 17 illustrates an example of a common NAS security context. In an example, the common NAS security context may comprise at least one or more identifiers for an access type, a cryptographic key, a NAS COUNT pair for a first access type, a NAS COUNT pair for a second access type, a key set identifier and/or the like. For example, the identifier of an access type may be at least one of a NAS connection identifier and/or the like. For example, the common NAS security context may comprise a first NAS connection identifier associated with the first access type and a second NAS connection identifier for the second access type. For example, the cryptographic key may be at least one of K_{AMF}, K_{NASint}, K_{NASenc} and/or the like. For example, the key set identifier may identify the K_{AMF} For example, the key set identifier may be a ngKSI, key set identifier (KSI) and/or the like.

In an example, an AMF may determine to update the K_{AMF} For example, the determining to update may be based on mobility e.g., moving from the AMF to a new AMF, a NAS COUNT wrap around, a high NAS COUNT value, a duration since the last successful primary authentication, an operator policy and/or the like. For example, a NAS COUNT wrap around may refer to a NAS COUNT value reaching a maximum value and restart at zero.

For example, update may refer to deriving a new K_{AMF}. For example, the deriving the new K_{AMF} may refer to a horizontal key derivation, a running a new primary authentication and/or the like. For example, the horizontal key derivation may refer to deriving the new K_{AMF} based on the K_{AMF} For example, in response to the horizontal key derivation the value of the ngKSI may be unchanged.

For example, the running a new primary authentication may refer to deriving a new K_{AMF} based on keying material from the running a new primary authentication. For example, in response to the running a new primary authentication, the ngKSI value may change.

In an example the NAS connection identifier may provide cryptographic separation. For example, cryptographic separation may refer to ensuring different results of a computation process or encryption process of different access types.

In an example, the NAS COUNT value pair may refer to a NAS COUNTs. For example, the NAS COUNTs may comprise at least one of a NAS uplink COUNT and a NAS downlink COUNT. For example, the NAS uplink COUNT may comprise a first NAS overflow counter and a first NAS SQN. For example, the first NAS SQN may be associated with the NAS uplink COUNT. For example, the first NAS SQN may be included in a first NAS message.

For example, the NAS uplink COUNT may be encoded as a first 16 bit NAS overflow counter and a first eight bit NAS SQN.

For example, a second NAS SQN may be included in a second NAS message. For example, the second NAS SQN may be associated with the NAS downlink COUNT. For example, a value of the NAS downlink COUNT may be incremented after being included in the second NAS message. For example, incrementing may mean increasing the value of the NAS downlink COUNT by one.

In an example, the NAS uplink COUNT may be associated with an access type. In an example, the NAS COUNTs associated with an access type may be used over the access type. For example, the NAS downlink COUNT may be encoded in the same way as the NAS uplink count.

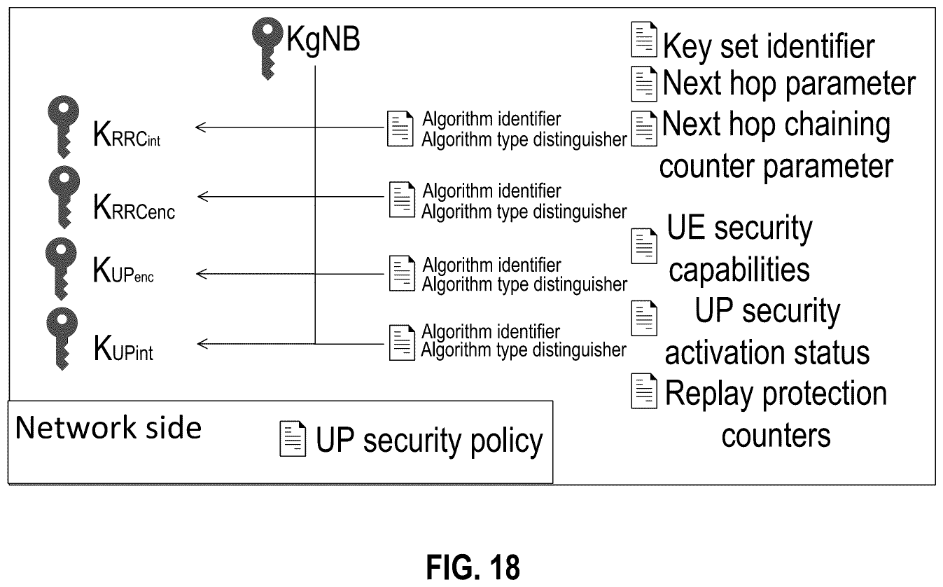

FIG. 18 may depict an example of an AS security context for 3GPP access. In an example, the AS security context for 3GPP access may comprise a key K_{gNB}, a key K_{RRCnt}, a key K_{RRCenc}, a key K_{UPenc}, a key KUPint, one or more algorithm identifier(s), one or more algorithm type distinguisher(s), a key set identifier, a next hop parameter, a next hop chaining counter parameter, a UE security capabilities, a UP security activation status, one or more replay protection counters.

For example, the key K_{gNB} may be used to derive and/or calculate keys for protection of data traffic at the AS layer. For example, the key K_{RRCint}, the key K_{RRCenc}, the key KUPint, the key K_{UPenc} may be derived based on the key K_{gNB}.

In an example, the key K_{RRCnt} may be used to integrity protect RRC traffic between a UE and a base station. For example, integrity protection may refer to being able to detect unauthorized modifications of RRC traffic between the base station and the UE.

In an example, the key K_{RRCenc} may be used to cipher traffic between the UE and the base station. For example, cipher may refer to an attacker not being able to read the clear text of RRC messages sent between the UE and the base station.

In an example, the key K_{UPenc} may be used to cipher user plane (UP) traffic between the UE and the base station. For example, cipher may refer to an attacker not being able to read the clear text of UP messages sent between the UE and the base station.

In an example, the key KUPint may be used to integrity protect user plane (UP) traffic between the UE and the base station. For example, integrity protection may refer to being able to detect unauthorized modifications of UP traffic between the base station and the UE.

In an example, the algorithm identifier may identify an integrity algorithm for 5G (NIA) or an encryption algorithm for 5G (NEA). For example, the NIA may be a NIA0, a NIA1, a NIA2 a NIA3 and or the like. For example, the NIA0 may be null integrity protection algorithm and/or the like. For example, the NIA1 may be 128-bit SNOW 3G based algorithm and/or the like. For example, the NIA2 may be 128-bit advanced encryption standard (AES) based algorithm and/or the like. For example, NIA3 may be 128-bit ZUC based algorithm and/or the like.

For example, the NEA may be a NEA0, a NEA1, a NEA2, a NEA3 and/or the like. For example, the NEA0 may be null ciphering protection algorithm and/or the like. For example, the NEA1 may be 128-bit SNOW 3G based algorithm and/or the like. For example, the NEA2 may be 128-bit AES in counter mode based algorithm and/or the like. For example, NEA3 may be 128-bit ZUC based algorithm and/or the like.

In an example, the algorithm type distinguisher may identify an intended use for a key. For example, the intended use may be N-RRC-enc-alg, N-RRC-int-alg, N-UP-enc-alg, N-UP-int-alg and/or the like. In an example the intended use may have a corresponding hexadecimal value. For example, the corresponding hexadecimal value may be used in a key derivation function.

In an example, the key set identifier may be a key set identifier in 5G (ngKSI). For example, the ngKSI may aid in uniquely identifying keys in the AS security context for 3GPP access.

In an example, the NH may be used to derive a new K_{gNB}. For example, the new K_{gNB} may be a KNG-RAN*. For example, the new K_{gNB} may be derived during an RRC state transition, a handover from the base station to a second base station and/or the like.

In an example, the next hop chaining counter parameter (NCC) may be used to identify how many NH-derivations have already been performed from an initial K_{gNB}. For example, the NCC may hold a value. For example, the value may be used to identify how many vertical key derivations have taken place from the initial K_{gNB}. For example, vertical key derivation may refer to deriving a new K_{gNB} based on the NH instead of a currently used K_{gNB}.

In an example, the UE security capabilities may indicate which NR AS algorithms for AS layer the UE supports. For example, if the UE supports evolved universal terrestrial radio access network (E-UTRAN) connected to 5GC, the UE security capabilities may include LTE algorithms for AS level.

In an example, the UP security activation status may indicate which security algorithms are associated with a PDU session.

In an example, the replay protection counters may be used to ensure a message on the AS layer is accepted only once. For example, the replay protection counter may be a PDCP COUNT. For example, the PDCP COUNT may be a 32 bit value. For example, the PDCP COUNT may be specific to a bearer. In an example, the PDCP COUNT may comprise two values, a first value for uplink messages and a second value for downlink messages and/or the like.

In an example, the AS security context for 3GPP access may on a network side hold a UP security policy. For example, the UP security policy may indicate which security is to be activated for a PDU session. For example, the UP security policy may indicate that ciphering is required for the PDU session, ciphering is preferred for the PDU session, ciphering is not needed and/or the like. For example, the UP security policy may indicate that integrity protection is required for the PDU session, integrity protection is not needed for the PDU session, integrity protection is preferred for the PDU session and/or the like.

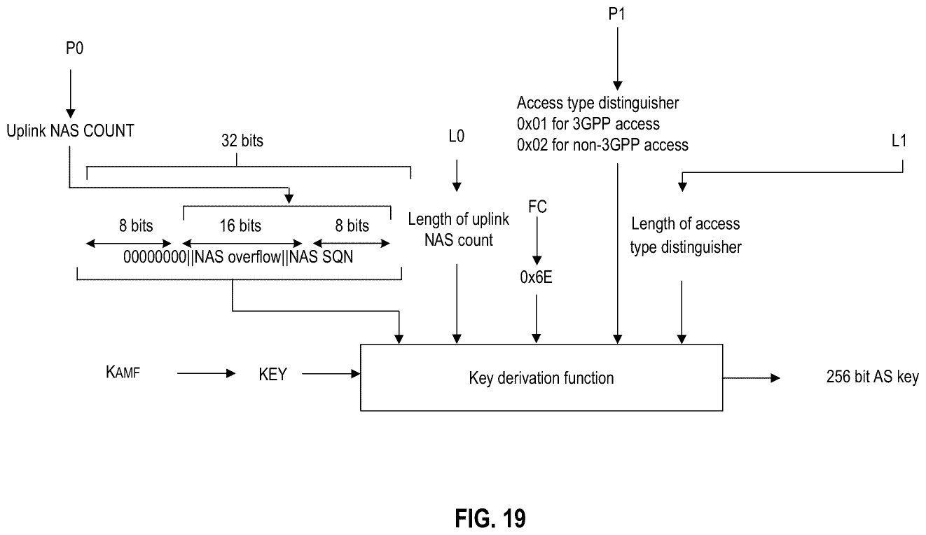

FIG. 19 illustrates an example of a derivation/calculation process of a 256 bit AS key. In an example, the derivation process may be based on a key derivation function. For example, the key derivation function may take a plurality of input parameters. For example, the plurality of input parameters may be a key, a uplink NAS COUNT, a length of the uplink NAS COUNT, an FC value, an access type distinguisher, a length of the access type distinguisher and/or the like.

For example, the key may be a K_{AMF}. For example, the uplink NAS COUNT may comprise a padding, a NAS overflow, a NAS SQN and/or the like. For example, the length of the uplink NAS COUNT may specify the length of the uplink NAS COUNT parameter.

For example, the FC value may be a unique value used by the key derivation function when deriving one or a plurality of 256 bit AS key(s).

For example, the access type distinguisher may be a value for distinguishing between different access types. For example, a value of 0x01 may refer to 3GPP access and a value of 0x02 may refer to non-3GPP access. For example, the length of the access type distinguisher may specify the length of the access type distinguisher parameter.

In an example, the derivation/calculation process results in a 256 bit AS key, if the derivation/calculation process used the access type distinguisher referring to 3GPP access the 256 AS key may be a K_{gNB}.

In an example, the derivation/calculation process results in a 256 bit AS key, if the derivation/calculation process used the access type distinguisher referring to non-3GPP access the 256 AS key may be a K_{N3IWF}.

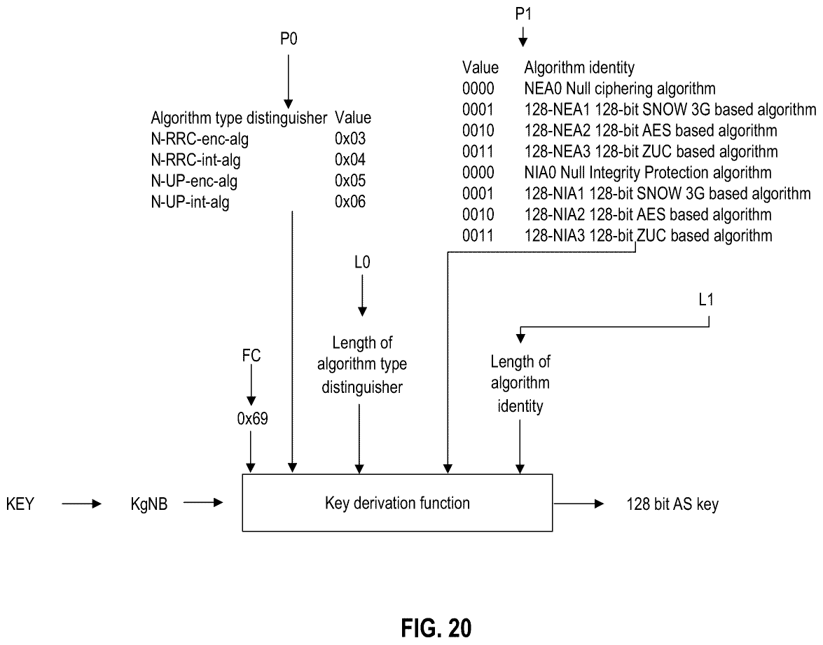

FIG. 20 illustrates an example of a derivation/calculation process of a 128 bit AS key. In an example, the derivation process may be based on a key derivation function. For example, the key derivation function may take a plurality of input parameters. For example, the plurality of input parameters may be a key, an algorithm type distinguisher, a length of the algorithm type distinguisher, an FC value, an algorithm identity, a length of the algorithm identity and/or the like.

For example, the key may be a K_{gNB} and/or the like.

For example, the algorithm type distinguisher may be a value identifying the purpose of a derived key. For example, the purpose may be ciphering of RRC traffic, integrity protection of RRC traffic, ciphering of UP traffic, integrity protection of UP traffic and/or the like.

For example, the length of the algorithm type distinguisher may be a value specifying the length of the value identifying the purpose of a derived key.

For example, the FC value may be a unique value used by the key derivation function when deriving one or a plurality of 128 bit AS key(s).

For example, the algorithm identity may have an associated value identifying which algorithm a key may be used with. For example, the algorithm identity may refer to NEA0 null ciphering algorithm, 128-NEA1 128-bit SNOW 3G based algorithm, 128-NEA2 128-bit AES based algorithm, 128-NEA3 128-bit ZUC based algorithm, NIA0 null integrity protection algorithm, 128-NIA1 128-bit SNOW 3G based algorithm, 128-NIA2 128-bit AES based algorithm, 128-NIA3 128-bit ZUC based algorithm and/or the like.

For example, the length of the algorithm identity may specify the length of the associated value.

In an example, the derivation/calculation process results in a 128 bit AS key.

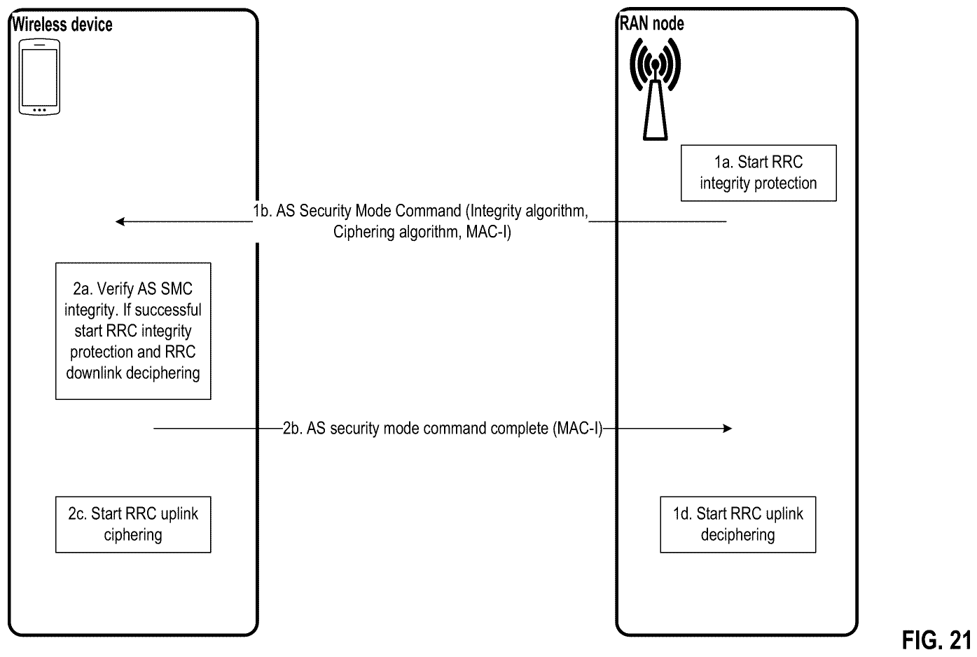

FIG. 21 illustrates an example of how AS security may be activated between a wireless device and a RAN node. For example, the RAN node may be a gNB, eNB, ng-eNB and/or the like. For example, the wireless device may be a UE.

In an example, the RAN node may start an integrity protection of RRC traffic. For example, the integrity protection of RRC traffic may be based on a key K_{RRCnt}. For example, the key K_{RRCnt} may be based on a current K_{gNB}. For example, the current K_{gNB} may mean the K_{gNB} is currently in use by the RAN node and the wireless device.

In an example, the RAN node may send a first RRC message to the wireless device. The first RRC message may comprise selected RRC and UP encryption/ciphering algorithms and integrity algorithms, a first message authentication code-integrity (MAC-I). For example, selected algorithms may be based on a UE security capabilities and/or a list of prioritized algorithms available in the RAN node. For example, the first RRC message may be a AS security mode command (SMC) message. The RAN node may start RRC downlink ciphering after sending the first RRC message.

In an example, the wireless device may receive the first RRC message. In response to receiving the first RRC message, the wireless device may determine/calculate an expected MAC-I based on the first RRC message and the key K_{RRCnt}. For example, if the expected MAC-I is identical to the first MAC-I received in the first RRC message the integrity verification may be successful.

In an example, in response to successfully verifying the integrity of the first RRC message, the wireless device may send a second RRC message comprising a second MAC-I, start RRC integrity protection, RRC downlink deciphering and/or the like.

In an example, the RAN node may receive the second RRC message. The RAN node may verify the integrity of the second MAC-I. After successful verification of the integrity of the second RRC message, the RAN node may start RRC uplink deciphering.

In an example, the wireless device may start uplink RRC ciphering after sending the second RRC message. For example, the second RRC message may be a security mode command complete message.

In an example, the wireless device may derive a K_{gNB}, the K_{RRCint}, a K_{RRCenc} in response to receiving the first RRC message.

In an example, a roundtrip of the AS security mode command message and the AS security mode command complete message may refer to a AS security mode command (SMC) procedure.

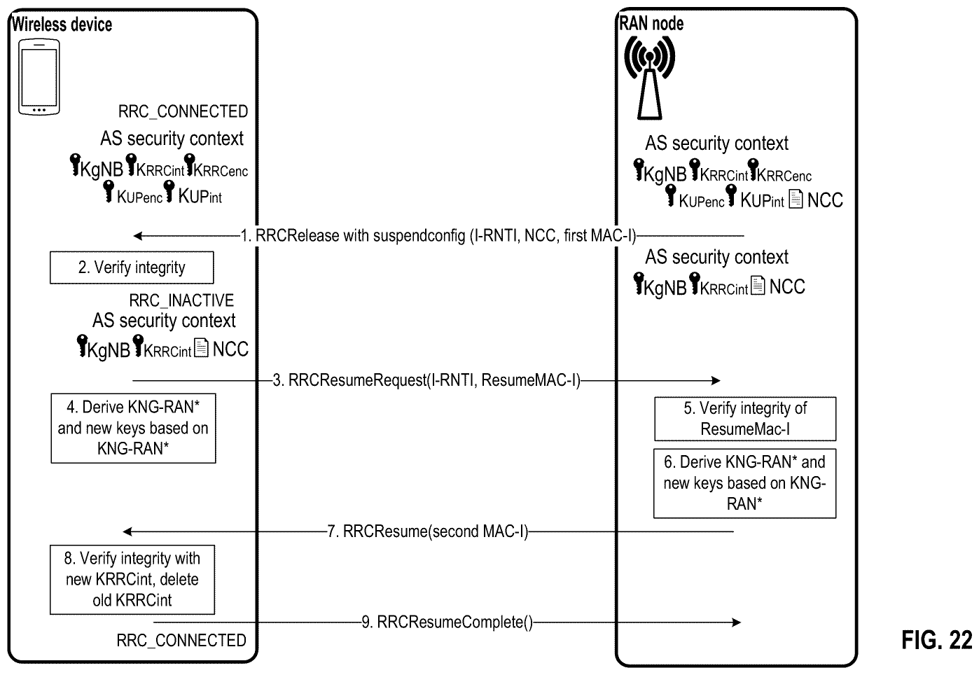

FIG. 22 may illustrate a wireless device transitioning from RRC_CONNECTED to RRC_INACTIVE and back to RRC_CONNECTED.

In an example the wireless may be in RRC_CONNECTED state. The wireless device and a RAN node may share an AS security context. For example, the AS security context may be an AS security context for 3GPP access. The AS security context may comprise one or several parameters and or one or several keys as depicted in FIG. 18. Reverting back to FIG. 22, the RAN node may send an RRCRelease with suspendconfig message to the wireless device. The RRCRelease with suspendconfig message may comprise an inactive-radio network temporary identifier (I-RNTI), an NCC a first MAC-I and/or the like.

For example, if the RAN node has an unused pair of {a new NCC, NH}, the RAN node includes the new NCC as the NCC in the RRCRelease with suspendconfig message. For example, if the RAN node does not have the unused pair of {the new NCC, NH}, the RAN node may include a current NCC associated with a current K_{gNB} as the NCC in the RRCRelease with suspendconfig message.

In an example, after sending the RRCRelease with suspendconfig message the RAN node may delete current AS keys. For example, current AS keys may be a K_{RRCenc}, a K_{UPenc} (if available), a K_{UPint} (if available). For example, delete may refer to removing from the AS security context. For example, if the NCC in the RRCRelease with suspendconfig message is associated with the unused pair of {the new NCC, NH} the RAN node may delete the current K_{gNB} and save the unused pair of {the new NCC, NH} in the AS context. For example, if the NCC in the RRCRelease with suspendconfig message is associated with the current K_{gNB}, the RAN node may keep the current K_{gNB} and the current NCC in the AS security context.

In an example, the wireless device may in response to receiving the RRCRelease with suspendconfig message verify the integrity of the RRCRelease with suspendconfig message by calculating an expected MAC based on the K_{RRCint}. If the expected MAC is identical to the first MAC-I received in the RRCRelease with suspendconfig message the integrity verification may be successful. For example, the integrity verification may be in the PDCP layer.

In an example, in response to verifying the integrity of the RRCRelease with suspendconfig message, the wireless device may delete keys in the AS security context.

In an example, the NCC received in the RRCRelease with suspendconfig message may be associated with the current K_{gNB}, the wireless device may keep the current K_{gNB} and K_{RRCint} in the AS security context. The remaining keys e.g., K_{RRCenc}, KUPint (if available), K_{UPenc} (if available) is/are removed from the AS security context. The wireless device may store the received NCC and the I-RNTI.

In an example, after the wireless device has removed the remaining keys and stored NCC and I-RNTI, the wireless device may be in RRC_INACTIVE state.

In an example, the wireless device may be in RRC_INACTIVE state and determine to transition to RRC_CONNECTED. For example, the determining may be based on the wireless device having uplink UP data to send and/or the like.

In an example, the wireless device may send a RRCResumeRequest message comprising the I-RNTI and a ResumeMAC-I. For example, the wireless device may calculate/determine the ResumeMAC-I based on a plurality of input parameters. For example, the plurality of input parameters may comprise a key input, a bearer input, a direction input, a count input, a message input and/or the like.

For example, the key input may be the K_{RRCnt}. For example, the bearer input may be set to all “1” s. For example, the direction input may be set to “1” s. For example, the count input may be set to all “1”s. For example, the message input may be set to a VarResumeMAC-Input. For example, the VARResumeMAC-Input may be encoded with source physical cell id (source PCI); target cell-id; source cell-radio network temporary identifier (C-RNTI).

In an example, after sending the RRCResumeRequest message the wireless device may derive new keys for protection of subsequent traffic between the wireless device and the RAN node. For example, the wireless device may derive a KNG-RAN*. The wireless device may use the KGN-RAN* to derive a new K_{RRCnt}, a new K_{RRCenc}, a new KUPint(optionally), a new KUPint(optionally) and/or the like.

In an example, the RAN node may receive the RRCResumeRequest message from the wireless device. In response to receiving the RRCResumeRequest message, the RAN node may extract the I-RNTI from the RRCResumeRequest message. The RAN node may based on the I-RNTI locate the AS security context.

In an example, the RAN node verifies the integrity of the ResumeMAC-I received in the RRCResumeRequest message by calculating an expected MAC. The RAN node may use the K_{RRCnt} located with the I-RNTI received in the RRCResumeRequest message.

In an example, the RAN node may successfully verify the integrity of the ResumeMAC-I if the expected MAC is identical to the ResumeMAC-I.

In an example, after a successful verification of the ResumeMAC-I, the RAN node may derive the KNG-RAN*, the new K_{RRCnt}, the new K_{RRCenc}, the new KUPint(optionally), the new KUPint(optionally) and/or the like.

In an example, the RRCResumeRequest message may be received by a new RAN node. In an example, the new RAN node may send a Xn-AP retrieve UE context request message to the RAN node. The RAN node may verify the ResumeMAC-I. The RAN node may after successful verification of the ResumeMAC-I send a Xn-AP retrieve UE context response message to the new RAN node comprising the KNG-RAN*, the new K_{RRCnt}, the new K_{RRCenc}, the new KUPint(optionally), the new KUPint(optionally), the AS security context and/or the like.

In an example, the RAN node may send a RRCResume message to the wireless device comprising a second MAC-I. For example, the RRCResume message may be ciphered with the new K_{RRCenc} and integrity protected with the new K_{RRCint}.

In an example, the wireless device may receive the RRCResume message.

In an example, the wireless device may decipher the RRCResume message based on the new K_{RRCenc}. The wireless device may verify the integrity of the RRCResume message by calculating a second expected MAC. For example, the second expected MAC may be based on the new K_{RRCint}. For example, the wireless device may successfully verify the integrity of the second expected MAC is identical to the second MAC-I.

In an example, after successfully verifying the integrity of the RRCResume message the wireless device update the AS security context. For example, update may refer to deleting the K_{RRCint} and saving the new K_{RRCnt}, the new K_{RRCenc}, the new KUPint(optionally), the new KUPint(optionally) and/or the like.

In an example, the wireless device may send a RRCResumeComplete message to the RAN node. For example, the RRCResumeComplete message may be integrity protected with the new K_{RRCnt} and ciphered with the new K_{RRCenc}. After sending the RRCResumeComplete message the wireless device may send UL data.

In an example, after sending the RRCResumeComplete message the wireless device may be in RRC_CONNECTED state.

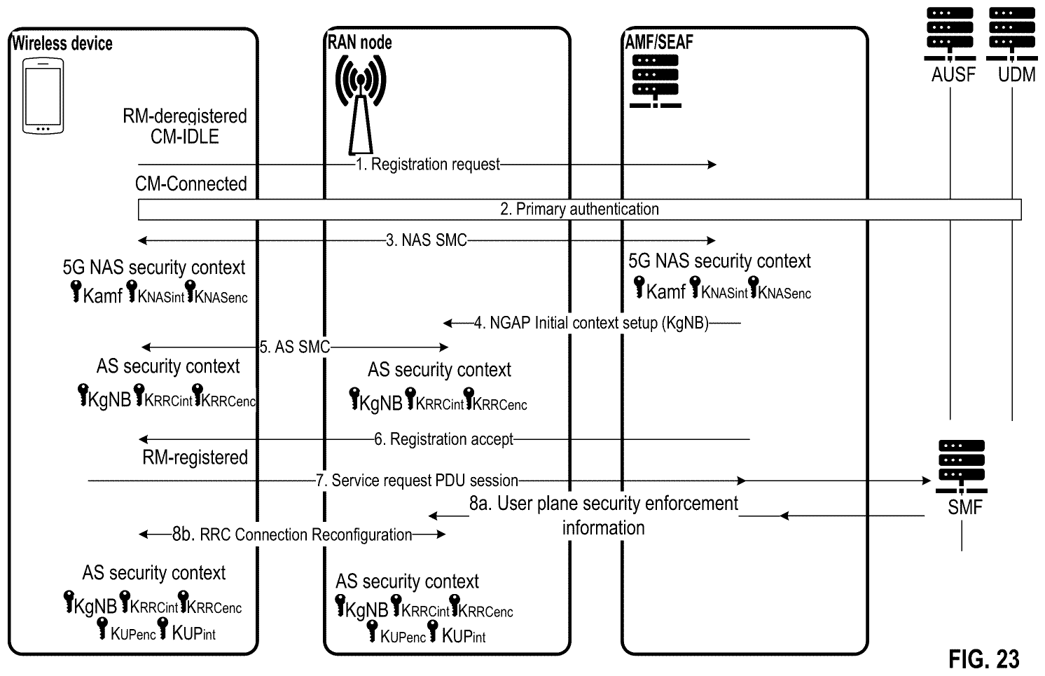

FIG. 23 may depict a wireless device establishing AS keys for UP traffic.

In an example, the wireless device may send a first registration request message to an AMF via a RAN node. In an example, the wireless device may be in a RM-DEREGSISTERED state and a CM-IDLE state before sending the first registration request. For example, RM-DEREGISTERED may refer to the wireless device not being registered with a network. For example, CM-IDLE may refer to the wireless device not having a signaling connection to the AMF. After sending the first registration request, the wireless device may be in CM-CONNECTED state. For example, CM-CONNECTED may refer to the wireless device having a signaling connection with the AMF.

In an example the first registration request message may be a NAS message. For example, the first registration request message may comprise at least one of an identifier, key set identifier in 5G (ngKSI) and/or the like. For example, the identifier may be at least one of a subscriber concealed identifier (SUCI), a 5G global unique temporary identifier (5G-GUTI), and/or the like. In an example, the first registration request message may be an initial NAS message.

In an example, in response to receiving the first registration request message, the AMF may determine a primary authentication of the wireless device (UE authentication) is needed.

In an example, the primary authentication of the wireless device may refer to run/perform primary authentication. In an example, the primary authentication may be based on 5G-AKA or EAP-AKA′, for a 5G SNPN the primary authentication may additionally be based on key generating EAP methods. An example of a key generating EAP method may be EAP-TLS.

In an example, the AMF may determine to run the primary authentication of the wireless device. For example, the primary authentication of the wireless device may be run as described in FIG. 15. Reverting back to FIG. 23, the AMF may after the successful primary authentication of the wireless device initiate a NAS SMC procedure. The NAS SMC procedure may be run as described in FIG. 15. Reverting back to FIG. 23. The AMF and the wireless device may hold a 5G NAS security context comprising a K_{AMF}, a KNASint, a KNASenc and/or the like.

In an example, after the NAS SMC procedure, the AMF may send an NGAP Initial context setup message comprising a K_{gNB} to the RAN node. For example, the K_{gNB} may be based on the K_{AMF}.

In an example, the RAN node may in response to receiving the NGAP initial context setup message decide to active AS security. For example, activate AS security may refer to initiating an AS SMC procedure with the wireless device as described in FIG. 21. Reverting back to FIG. 23 the RAN node and the wireless device may hold an AS security context comprising the K_{gNB}, a K_{RRCnt}, a K_{RRCenc} and/or the like. For example, the AS security context may be an AS security context for 3GPP.

In an example, the AMF may send a registration accept message to the wireless device. In response to receiving the registration accept message, the wireless device may transition to RM-registered state. For example, RM registered state may refer to the wireless device being registered with the network.

In an example, the wireless device may determine to send a service request for a PDU session message to an SMF. For example, the determining may be based on the wireless device wanting to connect to an application on the internet, has pending uplink data and/or the like. For example, the service request for a PDU session message may be a PDU session establishment request message.

In an example, the SMF may in response to receiving the service request for a PDU session message determine a user plane security enforcement information. For example, the user plane security enforcement information may be based on a UP security policy. For example, the UP security policy may be part of session management subscription information in a UDM or if the UDM does not hold any relevant information the user plane security enforcement information may be based on a local UP security policy configured in the SMF.

For example, the user plane security enforcement information may indicate if ciphering/encryption is “required”, “preferred”, “not needed” and/or the like for the requested PDU session.

For example, the user plane security enforcement information may indicate if integrity protection is “required”, “preferred”, “not needed” and/or the like for the requested PDU session.

In an example, the SMF may send the user plane security enforcement information to the RAN node via the AMF.

In an example, in response to receiving the user plane security enforcement information from the SMF via the AMF, the RAN node may send an RRC connection reconfiguration message to the wireless device. For example, if integrity protection and ciphering is required for the PDU session, the RAN node may in response to sending the RRC connection reconfiguration message derive/calculate a K_{UPenc} and a KUPint.

In an example, the wireless device may in response to receiving the RRC connection reconfiguration message determine to verify the RRC connection reconfiguration message. For example, verify may refer to deciphering the RRC connection reconfiguration message based on the K_{RRCenc} and/or verify the integrity of the RRC connection reconfiguration message based on the K_{RRCint} and/or the like.

In an example, the wireless device may derive the K_{UPenc} and/or KUPint based on the indications in the RRC connection reconfiguration message.

In an example, in response to successfully verifying the RRC connection reconfiguration message, the wireless device may send a RRC connection Reconfiguration complete message to the RAN node.

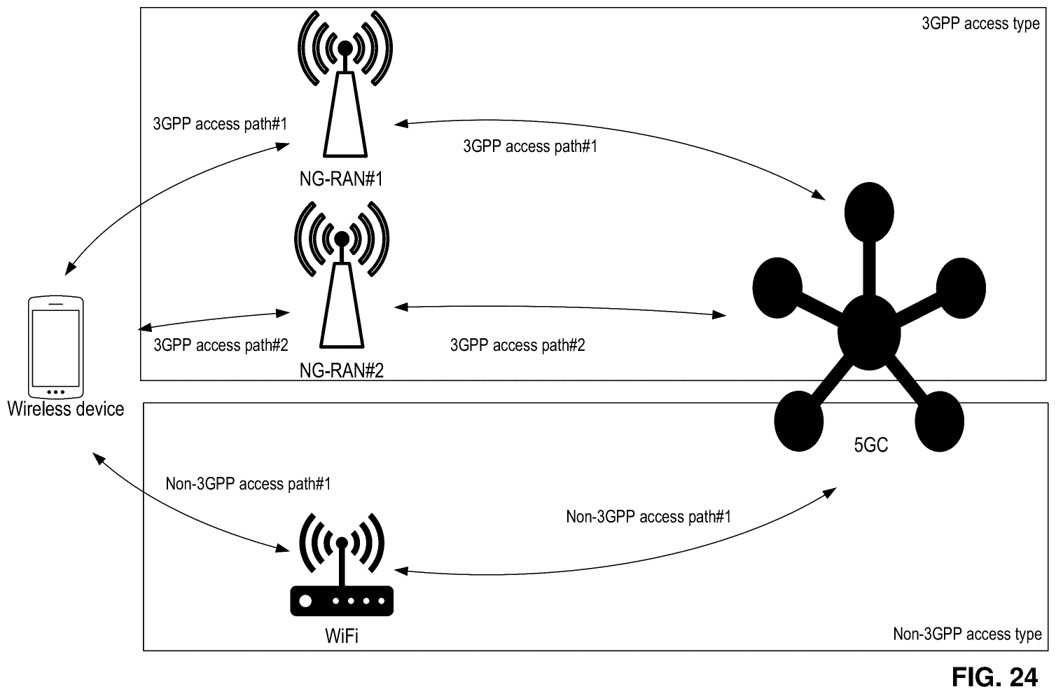

FIG. 24 may depict one example embodiment of the present disclosure. In an example, a wireless device may have one or multiple access paths of an access type established with a network. For example, the network may be a 5GC.

In an example embodiment of the present disclosure, a UE may establish (or use, configure) one or more access paths of an access type with a network. For example, the network may be at least one of a 5GC, evolved packet core (EPC) and/or the like. Each access path of the one or more access paths may refer to connection of a UE with the network. The access path may be referred to as access leg, connection, and/or the like. In an example, the access path may employ connectivity with the network wherein the connectivity may be via a radio access technology (RAT) type of an access type. In an example, the access type may be 3GPP access, or non-3GPP access. In an example, a RAT type of the 3GPP access may be NR, LTE, satellite, and/or the like. In an example, a RAT type of the non-3GPP access may be WiFi, WIMAX, and/or the like.

In an example, in conditions where the UE has an access path for an access type with a network, the UE may benefit from having additional access path(s) for the access type with the network. For example, the UE may be in an area where a first NG-RAN (e.g., via terrestrial 3GPP RAN) and a second NG-RAN (e.g., a non-terrestrial 3GPP RAN) are available. In an example, the UE may establish two connections (e.g., access paths) with the network of the same access type. For example, the UE may have two connections of the first access type with the network. In another example, the UE may have two connections of the first access type and one connection of the second access type with the network.

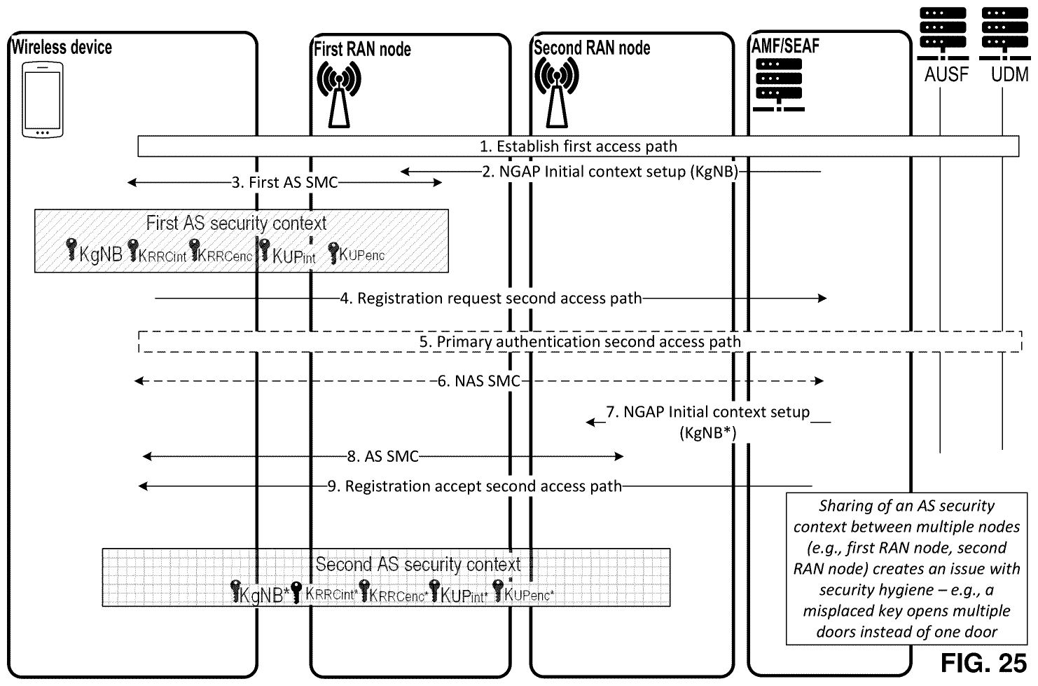

FIG. 25 illustrates an example of how technologies may work when two access paths of the same access type are configured.

In an example, a wireless device and a network may establish a first access path over a first access type via a first RAN node. For example, establish may refer to the wireless device registering, requesting registration, and/or being registered with the network over the first access path. For example, being registered with the network may refer to the wireless device being successfully authenticated by a primary authentication, the wireless device performing a first NAS SMC procedure with an AMF in the network, the wireless device performing a first AS SMC procedure with the first RAN node, the AMF sending a first K_{gNB} in an NGAP initial context setup message to the first RAN node, the wireless device sending a first registration request message to the network via the first RAN node, the wireless device receiving a first registration accept message from the network via the first RAN node establishing one or more security contexts and/or the like. For example, a security context may refer to a 5G NAS security context, a common security context, an AS security context for 3GPP access and/or the like.

In an example, the wireless device and the AMF may hold a common NAS security context. For example, hold may refer to the wireless device and the AMF being able to use one or a plurality of keys for protection of NAS traffic, one NAS COUNT pair per access path and/or the like. For example, protection may refer to cipher, integrity protection, replay protection and/or the like.

In an example, the wireless device and the first RAN node may hold a first AS security context. For example, hold may refer to the wireless device having a local copy of the first AS security context and the first RAN node having a local copy of the first AS security context. For example, the first AS security context may comprise one or more keys. For example, the one or more keys may comprise a K_{gNB}, a K_{RRCint}, a K_{RRCenc}, a K_{UPinc}, a K_{UPenc} and/or the like. For example, the K_{gNB}, the K_{RRCint}, the K_{RRCenc}, the K_{UPinc}, the K_{UPenc} and/or the like may be set to one or more first values (e.g., K_{gNB}1, the K_{RRCnt}1, the K_{RRCenc}1, the K_{UPinc}1, the K_{UPenc}1) resulting from the first AS SMC. For example, the K_{gNB}1 may be K_{gNB}.

For example, the wireless device and the first RAN node may use the one or more keys from the first AS security context for sending/receiving one or more RRC messages, and/or one or more data packets (e.g., packets, user data). For example, the wireless device and the first RAN node may calculate one or more MAC values for the one or more RRC messages with the one or more keys and/or may include the MAC values in the one or more RRC messages. For example, the wireless device and the first RAN node may encrypt (or decrypt) one or more data packets with the one or more keys from the first AS security context.

For example, the wireless device may use the K_{RRCint}1 to calculate a message authentication code (MAC) for an RRC message. For example, the wireless device may send the RRC message to the first RAN node. The first RAN node may in response to receiving the RRC message, verify the integrity of the RRC message based on the K_{RRCint}1.

In an example, the wireless device may send a second registration request message for a second access path over the first access type via a second RAN node.

In an example, the AMF may in response to receiving the second registration request message for the second access path message, determine to use the common NAS security context (e.g., established during the registration of the first access path (of the first access type). In an example, the determining may be based on the AMF having the valid security context available locally for the wireless device associated with the 5G-GUTI received in the second registration request message for the second access path and successful integrity verification of the integrity of the registration request message for the second access path.

For example, determine to use the common NAS security context may refer to not performing a second NAS SMC to active the common NAS security context on the second access path.

In an example, the AMF may send a K_{gNB}* to the second RAN node.

In an example, the AMF may send a second registration accept message for the second access path via the second RAN node to the wireless device.

In an example, the second RAN node may in response to receiving the K_{gNB}* perform a second AS SMC procedure with the wireless device over the second access path.

In an example, the second AS SMC procedure may replace keys in the first AS security context in the wireless device. For example, the second AS SMC procedure may result in generation of one or more second values (e.g., K_{gNB}*, the K_{RRCint}*, the K_{RRCenc}*, the K_{UPinc}*, the K_{UPenc}*). For example, the second AS security context may replace the first AS security context in the wireless device.

In an example, the K_{gNB}1 and the K_{gNB}* may be identical. For example, the K_{gNB}1 and the K_{gNB}* may be identical if the wireless device can be aware of an AS security context the keys in the AS security context may be identical to enable protection of communication of the first access path and the second access path. For example, the K_{gNB}1 and the K_{gNB}* may be identical if a first NAS COUNT value associated with the first access path and a second NAS COUNT value associated with the second access path are the same and/or the like. In this case, the AMF may send K_{gNB}1 and the K_{gNB}* of the same value, to the first RAN node and/or the second RAN node. For example, if the K_{gNB}1 and the K_{gNB}* are of the same value, K_{RRCnt}1 and K_{RRCint}* may be identical and/or the like. For example, the wireless device may communicate with the first RAN node and the second RAN node based on the one or more second keys.

Using the same keys in the first RAN node and the second RAN node may degrade security hygiene. For example, if the same keys are compromised in the first RAN node, communication between the wireless device and the second RAN node may be vulnerable to a security attack. For example, an attacker can use the same keys from the compromised first RAN node, to send illegitimate message to the wireless device over the second access path (e.g., as if the illegitimate message is sent by the second RAN node).

In another example, the K_{gNB}1 may be different from the K_{gNB}*. In this case, the second AS SMC procedure may disrupt communication between the first RAN node and the wireless device. For example, while the one or more keys in the wireless device are updated, the one or more keys in the first RAN node may not be updated after the second AS SMC procedure. For example, the wireless device may use the K_{RRCint}* to calculate a message authentication code (MAC) for an RRC message. For example, the wireless device may send the RRC message to the first RAN node. The first RAN node may in response to receiving the RRC message, verify the integrity of the RRC message based on the K_{RRCnt}1. Because the key used by the wireless device (e.g., the K_{RRCint}*) is different from the key used by the first RAN node (e.g., the K_{RRCnt}1), the first RAN node may discard the received RRC message. For example, the first RAN node may discard the received RRC message in response to unsuccessful verification of the integrity of the RRC message.

In existing technologies, as shown in FIG. 15 a wireless device may have an access path of 3GPP access (via a gNB) and another access path of non-3GPP access (via a N3IWF). For the 3GPP access path, the wireless device may perform an AS SMC procedure (e.g., with a RAN node) to first establish security keys. For the non-3GPP access path, the wireless device may establish an IPsec SA to second establish security keys. For a given access path, the security keys may be used to protect traffic of the wireless device.

As 5G system (5GS) evolves, the wireless device may have multiple access paths of the same access type. For example, the wireless device may have a first access path for a first 3GPP access and a second access path for a second 3GPP access. For example, the multiple access paths of 3GPP access may be established with a network via different RAN nodes.

The multiple access paths of the same access type (e.g., 3GPP access type) may both be configured to rely on AS SMC to establish security keys. If the wireless device performs a first AS SMC procedure for a first access path (of the multiple access paths), and performs a second AS SMC procedure for a second access path (of the multiple access paths), then the first and second procedures may generate the same security keys. As a result, there is a risk for degraded security hygiene where security keys may be reused in multiple RAN nodes, disrupting an access path's communication security and/or the like. If one set of security keys is compromised, it may be used to disrupt multiple access paths (e.g., via multiple RAN nodes). As shown in FIG. 25, multiple access paths (of the same access type) may lead to a security attack, disruption of communication and/or the like.

In examples of this disclosure, the handling of security keys may be enhanced. For example, an AMF may determine a first AS key for a first access path of an access type of a plurality of access paths of the access type based on an identifier of the first access path. The AMF may send the first AS key to a first RAN node. For example, the first AS key may be a K_{gNB}. In examples of this disclosure, the wireless device may handle AS security contexts independently per access path (of the same access type). By implementing the aforementioned solution, the multiple access paths (of the same access type) may help to keep good security hygiene, reduce potential disruption, and improve user experience.

In the specification, the term “access path” may be interpreted as a path between a UE and a network for exchange of data and/or signaling. The access path may be a logical connection, a route, an access channel and/or the like. The access path may be associated with a control plane path from a UE to a RAN, a path from a UE to a core network, a path from a RAN to a core network, the like, and/or a combination thereof. For example, an access path may be an access route, an access leg, and/or the like.

For example, each access type may have one or more access paths, each access path may be capable of transporting signalling messages. For example, there may be one or several established access paths between a UE and an AMF. For example, each access path may have a control plane. For example, a UE may have one or more 3GPP access paths. The one or more 3GPP access paths may be defined/established/associated for 3GPP access type.

For example, the one or more 3GPP access path may comprise at least one of:
one or more first-type 3GPP access paths: A first-type 3GPP access path may be a route associated a UE, a NG-RAN, a core network.
one or more second-type 3GPP access paths: A second-type 3GPP access path may be a route associated a UE, a E-UTRAN, a core network.

For example, a UE may have one or more N3GPP access paths:
one or more first-type N3GPP access paths: A first-type N3GPP access path may be a route associated a UE, a N3IWF, a core network.
one or more second-type N3GPP access paths: A second-type N3GPP access path may be a route associated a UE, a WiFi network, a core network.

In this specification “5G NAS security context” may include a key K_{AMF} with an associated key set identifier, a UE security capabilities, uplink and downlink NAS COUNT values and/or the like. A 5G NAS security context may be considered to be a “full 5G NAS security context” if the 5G NAS security context additionally contains a key K_{NASint}, a key K_{NASenc} and associated identifiers of the selected NAS integrity and encryption algorithms. The key K_{NASint} may be used for integrity protection of NAS messages. The key K_{NASenc} may be used for confidentiality protection of NAS messages. A 5G NAS security context may be mapped. For example, mapped may refer to the key K_{AMF} being derived based on evolved packet system (EPS) parameters. For example, EPS parameters may be a key K_{ASME}, EPS NAS uplink COUNT and/or the like.

In this specification “full 5G NAS security context” may be interpreted as a key K_{AMF} with an associated key set identifier, a UE security capabilities, uplink and downlink NAS COUNT values, a key K_{NASint} and a key K_{NASenc} and associated identifiers of the selected NAS integrity and encryption algorithms, and/or the like. For example, the key K_{AMF} may be derived based on a successful run of primary authentication. For example, the key set identifier may be a ngKSI and or the like. In an example, the ngKSI may identify the K_{AMF} For example, the UE security capabilities may refer to which cryptographic algorithms the UE can use. For example, the key K_{NASint} may be derived based on at least the key K_{AMF} For example, the key K_{NASint} may be used to integrity protect NAS messages. For example, integrity protect may refer to detecting tampering of NAS messages.

In an example, the key K_{NASint} may be derived during a NAS SMC procedure. For example, the key K_{NAsenc} may be derived based on at least the key K_{AMF} For example, the key K_{NAsenc} may be used to provide confidentiality protection of NAS messages. For example, confidentiality protection may refer to encrypting NAS messages. For example, encrypting may mean that no one without the key K_{NAsenc} may read the content of NAS messages encrypted with the key K_{NAsenc}. In an example, the key K_{NAsenc} may be derived during a NAS SMC procedure.

For example, the associated identifiers of the selected NAS integrity and encryption algorithms may be values that identify a cryptographic algorithm and if a key is used for integrity protection or confidentiality protection.

In this specification “partial native 5G security context” may include a key K_{AMF} with an associated key set identifier, a UE security capabilities, and uplink and downlink NAS COUNT values, which are initially set to zero before a first NAS SMC procedure for this security context. For example, a partial native 5G security context may be created in response to a successful primary authentication, for which no corresponding successful NAS SMC has been run. A partial native context may be in the state “non-current”. For example, non-current may mean the partial native 5G security context is not currently used by a UE and an AMF. For example, after a successful NAS SMC a partial native security context may transition into a “full native 5G security context”. For example, native may refer to the key K_{AMF} being created as a result of primary authentication, the full native 5G security context being identified by an ngKSI and/or the like.

In this specification “a common NAS security context” may include a key K_{AMF} with an associated key set identifier, a UE security capabilities, an uplink and downlink NAS COUNT value per access type, a NAS connection identifier per access type and/or, a common key K_{NASint} for integrity protection of NAS messages, a common key K_{NASenc} for encryption of NAS messages and/or the like. For example, the common NAS security context may hold the uplink and downlink NAS COUNT values for a 3GPP access type and a non-3GPP access type. For example, the uplink and downlink NAS COUNT values for 3GPP access type and non-3GPP access type may be added to the common NAS security context during the registration process of a first access type.

In this specification, “common AS security context” may refer to parameters specific to AS level for the one or several access path(s). For example, the parameters specific to AS level may be a one or several algorithm identifier(s), a one or several algorithm type distinguisher(s), a key set identifier, a UE security capabilities. For example, the one or several algorithm identifier(s) may be associated with a plurality of keys in the one or several AS sub-security contexts. For example, the one or several algorithm type distinguisher(s) may be associate with a plurality of keys in the one or several AS sub-security contexts. In an example, a common AS security context may be dynamically expanded with a one or several AS sub-security context(s) wherein the one sub AS security context may be associated with an access path. For example, the common AS security context may be part of a 5G security context. For example, the dynamically added may refer to adding the AS sub-security context to the common AS security context. For example, adding to the existing common AS security context may refer to expanding the common AS security context by adding the AS sub-security context to the common AS security context.

For example, the expanding the common AS security context may occur during a AS SMC for a new access path, during registration of a new access path and/or the like.

The AS sub-security context may be removed from the common AS security context in response to deregistering from an access path, transitioning into RRC_IDLE and/or the like.

In this specification, “AS sub-security context” may refer to parameters specific to an access path on AS level. For example, the parameters specific to an access path may a K_{gNB}, a K_{N3IWF}, a K_{RRCnt}, a K_{RRCenc}, a K_{UPenc}, a KUPint, a NH, a NCC, a UE security capabilities, a UP security activation status, a one or several replay protection counters, an access path distinguisher and/or the like. In an example, an AS sub-security context may be dynamically added to at least one of a common AS security context.

In an example, the AS sub-security context may be associated with an access type e.g., 3GPP or non-3GPP.

In this specification, “5G security context” may comprise one or several AS sub-security context(s), a common NAS security context, a common AS security context and/or the like. For example, a K_{gNB} may be uniquely identified within a 5G security context based on a ngKSI and a unique identifier for an AS sub-security context, a unique identifier for the K_{gNB} and/or the like. For example, the unique identifier may be an access path distinguisher and/or the like.

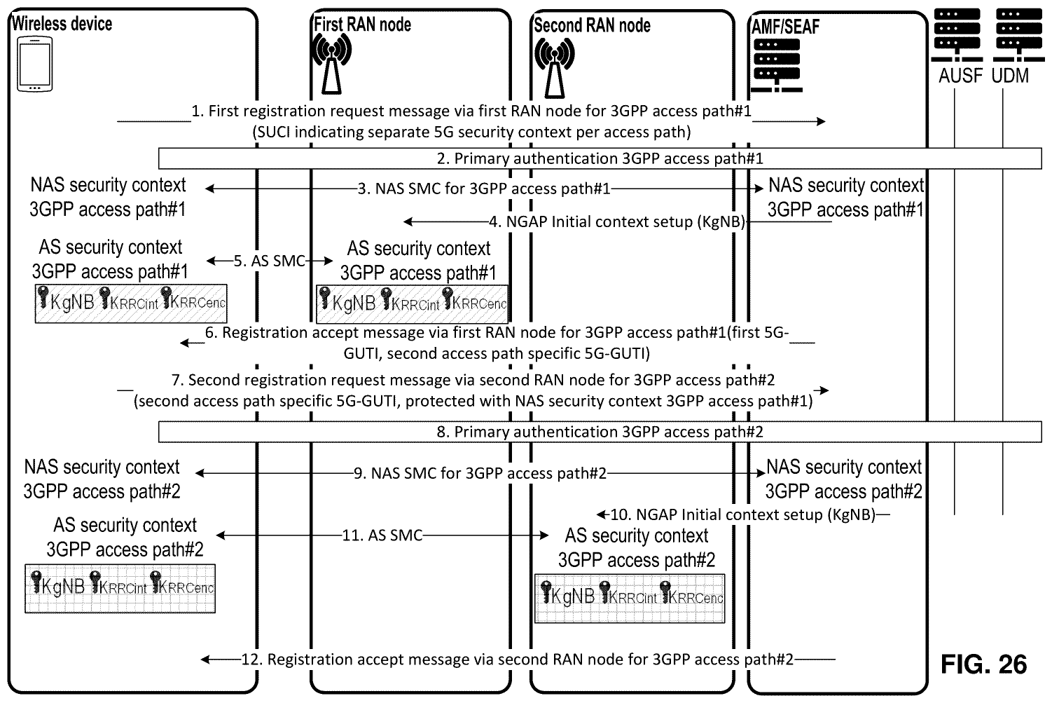

FIG. 26 may depict one example embodiment of the present disclosure. In an example, a wireless device may have one or multiple access paths of an access type established with a network.

In an example, a wireless device may send a first registration request message for a first 3GPP access path (a 3GPP access path #1) via a first RAN node to an AMF. For example, 3GPP access may be a first access type. In an example the first registration request message may be a NAS message. For example, the first registration request message may comprise of an identifier, ngKSI, NAS SQN number and/or the like. For example, the identifier may be at least one of a SUCI, a first 5G-GUTI, and/or the like. In an example, the first registration request message may be an initial NAS message. For example, if the wireless device has a 5G-GUTI, the wireless device may include the 5G-GUTI in the first registration request message.

In an example, the SUCI may comprise a SUPI type, a home network identifier, a routing indicator, a protection scheme id, a home network public key id, a scheme output and/or the like. For example, the SUPI type may identify the format of the SUPI concealed within the SUCI. For example, the home network identifier may depending on the SUPI comprise a mobile country code (MCC) and mobile network code (MNC) or a string of characters representing a domain name and/or the like. For example, the routing indicator may aid in routing the SUCI to a UDM and/or AUSF that can serve the wireless device. For example, the protection scheme identifier may aid in identifying how the SUPI has been concealed. For example, the home network public key id may comprise a public key. For example, the scheme output may comprise an encrypted SUPI.

In an example, the wireless device may send the first registration request message for the first 3GPP access path via the first RAN node to the AMF, wherein the registration request message may comprise the SUCI.

In an example, the SUPI type of the SUCI may indicate the wireless device prefers separate security contexts. For example, prefers separate security contexts may refer to a separate 5G NAS security context per 3GPP access path. For example, separate may refer to not having a common NAS security context when the wireless device has simultaneous 3GPP access paths established with the AMF.

In an example, in response to receiving the first registration request message from the wireless device, the AMF may determine the wireless device prefers separate security contexts. For example, determine may refer to inspecting the SUPI type of the SUCI. For example, a specific value of the SUPI type of the SUCI may indicate preference for separate security contexts.

In an example, in response to determining by the AMF the wireless device prefers separate security context, the AMF may determine to authenticate the wireless device. In an example, the determining may be based on if the registration request comprises a SUCI, based on an operator policy and/or the like. In an example, the absence of a valid security context available locally in the AMF's local storage may result in the AMF running authentication. For example, valid security context may refer to the wireless device and the AMF being allowed to use the security context, security context currently in use by the wireless device and the AMF and/or the like.

In an example, the authentication may refer to primary authentication. In an example, the primary authentication may be based on 5G-AKA EAP-AKA′, for a 5G network and for SNPNs the primary authentication may additionally be based on key generating EAP methods. An example of a key generating EAP method may be EAP-TLS.

In an example, in response to running primary authentication the AMF and wireless device may activate a first security context. In an example, the AMF may initiate a first NAS SMC procedure. For example, the AMF may send a first NAS security mode command (SMC) message to the wireless device, wherein the first NAS security command message may comprise an indicator the first security context may be used over the first 3GPP access path. For example, the first security context may comprise one or more key(s), a NAS connection identifier, a NAS COUNT values and/or the like. For example, the key(s) may be at least one of a first K_{AMF}, a first K_{NASint}, a first K_{NASenc} and/or the like. For example, the first security context may be a 5G NAS security context. For example, the first security context may be part of a first 5G security context.

In an example, after the first NAS SMC procedure, the AMF may send a first NGAP Initial context setup message comprising a first K_{gNB} to the first RAN node. For example, the first K_{gNB} may be based on the first Kamf.

In an example, the first RAN node may in response to receiving the first NGAP initial context setup message decide to active AS security. For example, activate AS security may refer to initiating a first AS SMC procedure with the wireless device over the first 3GPP access path as described in FIG. 21. Reverting back to FIG. 26 the first RAN node and the wireless device may hold an AS security context 3GPP access path #1. For example, the AS security context 3GPP access path #1 may comprise a one or more keys. For example, the one or more keys may comprise a K_{gNB}, a K_{RRCnt}, a K_{RRCenc} and/or the like. For example, the K_{gNB}, the K_{RRCint}, the K_{RRCenc}, and/or the like may be set to one or more first values (e.g., K_{gNB}1, the K_{RRCint}1, the K_{RRCenc}1) resulting from the first AS SMC. For example, the K_{gNB}1 may be the first K_{gNB}.

For example, the AS security context 3GPP access path #1 may be an AS security context for 3GPP.

In an example, the AMF may send a first registration accept message for the first 3GPP access path via the first RAN node, to the wireless device. The first registration accept message may comprise a first 5G-GUTI and a second 3GPP access path specific 5G-GUTI. For example, the first 5G-GUTI may be used for signaling on the first 3GPP access path. For example, the second 3GPP access path specific 5G-GUTI may be used by the wireless device to request a second 3GPP access path (3GPP access path #2). For example, the AMF may associate the second 3GPP access specific 5G-GUTI with the first security context. For example, the AMF may determine the wireless device is requesting a second 3GPP access path based on receiving the second 3GPP access path specific 5G-GUTI from the wireless device in a registration request.

In an example, the AMF may include the second 3GPP access path specific 5G-GUTI based on receiving the indication for separate security contexts in the first registration request message.

In an example, the wireless device may receive the first registration accept message. For example, the wireless device may use the first 5G-GUTI for signaling over the first 3GPP access path. For example, the wireless device may use the second 3GPP access path specific 5G-GUTI to establish the second 3GPP access path.

In an example, the wireless device may determine to establish the second 3GPP access path. For example, the determining may be based on the need for more bandwidth, support for MA PDU sessions, and/or the like.

In an example, the wireless device may send a second registration request message for the second 3GPP access path via a second RAN node to the AMF, wherein the second registration request message may comprise the second 3GPP access path specific 5G-GUTI. For example, the wireless device may protect the second registration request message based on the first security context.

In an example, the AMF may receive the second registration request message from the wireless device. In an example, the AMF may locate within the AMF's local storage the first security context based on the second 3GPP access path specific 5G-GUTI and verify the second registration request message. For example, verifying may refer to verifying the integrity of the second registration request based on the first security context. For example, verifying may refer to deciphering the second registration request message based on the first security context and/or the like. In an example, the AMF may locate the first security context based on receiving the second registration request message.

In an example, the second registration request message may comprise the second 3GPP access path specific 5G-GUTI. In an example, (when the second registration request message comprises the second 3GPP access path specific 5G-GUTI), the AMF may determine not to use the first security context to protect traffic over the second 3GPP access path.

In an example, based on receiving the second 3GPP access path specific 5G-GUTI the AMF may determine the wireless device is requesting a second 3GPP access path. In an example, the AMF may not be allowed to establish a common security context to be used with the first 3GPP access path and the second 3GPP access path upon receiving the second 3GPP access path specific 5G-GUTI. In an example, the AMF may trigger a run of primary authentication in response to receiving the second 3GPP access path specific 5G-GUTI and/or the like.

In an example, the AMF may in response to verifying the second registration request message trigger a second primary authentication over the second 3GPP access path of the wireless device.

In an example, in response to running the second primary authentication the AMF and wireless device may activate a second security context. In an example, the AMF may initiate a second NAS SMC procedure. For example, the AMF may send a second NAS security mode command (SMC) message to the wireless device, wherein the second NAS security command message may comprise an indicator indicating the second security context may be used over the second 3GPP access path. For example, the second security context may comprise one or more key(s), a NAS connection identifier, a NAS COUNT values and/or the like. For example, the one or more key(s) may be at least one of a second K_{AMF}, a second K_{NASint}, a second K_{NAsenc} and/or the like. For example, the second K_{AMF} may be calculated using (based on) at least identifier associated with the second access path and/or the like. For example, the second security context may be a 5G NAS security context. For example, the second security context may be part of the first 5G security context.

In an example, after the second NAS SMC procedure, the AMF may send a second NGAP Initial context setup message comprising a second K_{gNB} to the second RAN node. For example, the second K_{gNB} may be based on the second K_{AMF}.

In an example, the second RAN node may in response to receiving the second NGAP initial context setup message decide to active AS security. For example, activate AS security may refer to initiating a second AS SMC procedure with the wireless device over the second 3GPP access path as described in FIG. 21. Reverting back to FIG. 26 the second RAN node and the wireless device may hold an AS security context 3GPP access path #2. For example, the AS security context 3GPP access path #2 may comprise a one or more keys. For example, the one or more keys may comprise a K_{gNB}, a K_{RRCnt}, a K_{RRCenc} and/or the like. For example, the K_{gNB}, the K_{RRCnt}, the K_{RRCenc}, and/or the like may be set to one or more first values (e.g., K_{gNB}2, the K_{RRCnt}2, the K_{RRCenc}2) resulting from the first AS SMC. For example, the K_{gNB}2 may be the second K_{gNB}.

For example, the AS security context 3GPP access path #2 may be an AS security context for 3GPP.

For example, the wireless device and the first RAN node may use the one or more keys for sending/receiving one or more RRC messages, and/or one or more data packets (e.g., packets, user data) based on the AS security context 3GPP access path #1. For example, the wireless device and the first RAN node may calculate one or more MAC values for the one or more RRC messages with the one or more keys and/or may include the MAC values in the one or more RRC messages. For example, the first RAN node and the wireless device may base the calculation of one or more MAC values on the K_{RRCnt}1. For example, the wireless device and the first RAN node may encrypt (or decrypt) one or more data packets with the one or more keys. For example, the first RAN node and the wireless device may encrypt/decrypt based on the K_{RRCenc}1.

For example, the wireless device and the second RAN node may use the one or more keys for sending/receiving one or more RRC messages, and/or one or more data packets (e.g., packets, user data) based on the AS security context 3GPP access path #2. For example, the wireless device and the second RAN node may calculate one or more MAC values for the one or more RRC messages with the one or more keys and/or may include the MAC values in the one or more RRC messages. For example, the second RAN node and the wireless device may base the calculation of one or more MAC values on the K_{RRCnt}2. For example, the wireless device and the second RAN node may encrypt (or decrypt) one or more data packets with the one or more keys. For example, the second RAN node and the wireless device may encrypt/decrypt based on the K_{RRCenc}2.

In an example, the AMF may send a second registration accept message for the second 3GPP access path via the second RAN node, to the wireless device.

The proposed embodiment may provide signaling to allow the wireless device to have independent security for the first 3GPP access path and the second 3GPP access path.

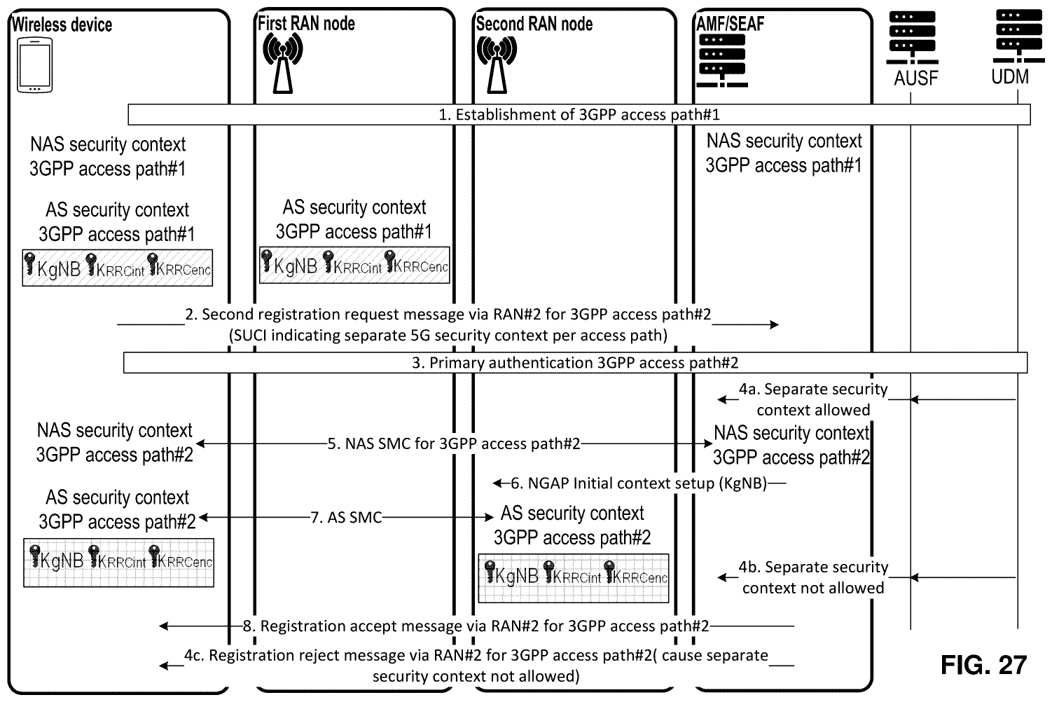

FIG. 27 may depict one example embodiment of the present disclosure. In an example, a wireless device may have one or multiple access paths of an access type established with a network.

In an example, a wireless device and a network may establish a first 3GPP access path (3GPP access path #1) via a first RAN node. For example, establish may refer to the wireless device being registered with the network over the first 3GPP access path. For example, being registered with the network may refer to the wireless device being successfully authenticated by a first primary authentication, the wireless device performing a first NAS SMC procedure with an AMF in the network, the wireless device performing a first AS SMC procedure with the first RAN node, the AMF sending a first K_{gNB} in an NGAP initial context setup message to the first RAN node, the wireless device sending a first registration request message comprising a first SUCI to the network via the first RAN node, the wireless device receiving a first registration accept message from the network via the first RAN node establishing one or more security contexts and/or the like. For example, a security context may refer to a 5G NAS security context (NAS security context 3GPP access path #1), a common security context, an AS security context for 3GPP access (AS security context 3GPP access path #1), a first 5G security context and/or the like. For example, the AS security context 3GPP access path #1 may comprise a one or more keys. For example, the one or more keys may comprise a K_{gNB}, a K_{RRCint}, a K_{RRCenc} and/or the like. For example, the K_{gNB}, the K_{RRCint}, the K_{RRCenc}, and/or the like may be set to one or more first values (e.g., K_{gNB}1, the K_{RRCnt}1, the K_{RRCenc}1) resulting from the first AS SMC. For example, the K_{gNB}1 may be the first K_{gNB}.

In an example, a second SUCI may comprise a SUPI type, a home network identifier, a routing indicator, a protection scheme id, a home network public key id, a scheme output and/or the like. For example, the SUPI type may identify the format of the SUPI concealed within the second SUCI. For example, the home network identifier may depending on the SUPI comprise a MCC and a MNC or a string of characters representing a domain name and/or the like. For example, the routing indicator may aid in routing the second SUCI to a UDM and/or AUSF that can serve the wireless device. For example, the protection scheme identifier may aid in identifying how the SUPI has been concealed. For example, the home network public key id may comprise a public key. For example, the scheme output may comprise an encrypted SUPI.

In an example, the SUPI type of the second SUCI may indicate the wireless device prefers separate security contexts. For example, prefers separate security contexts may refer to a separate 5G NAS security context per 3GPP access path. For example, separate may refer to not having a common NAS security context when the wireless device has simultaneous 3GPP access paths established with the AMF.

In an example, the wireless device may determine to establish a second 3GPP access path (3GPP access path #2). For example, the determining may be based on the need for more bandwidth, support for MA PDU sessions, and/or the like.

In an example, the wireless device may send a second registration request message for the second 3GPP access path via a second RAN node to the AMF, wherein the second registration request message may comprise the second SUCI.

In an example, the AMF may receive the second registration request message from the wireless device. In response to receiving the second registration request message, the AMF may determine to run a second primary authentication over the second access path. For example, the AMF may send a Nausf_UEAuthentication_Authenticate request message comprising the second SUCI to an AUSF to initiate the second primary authentication. In an example, a SEAF collocated with the AMF may send the Nausf_UEAuthentication_Authenticate request message.

In an example, the AMF may send a Nudm_UEAuthentication_Get request message to a UDM in response to receiving the Nausf_UEAuthentication_Authenticate request message. For example, the UDM may host a SIDF. For example, the SIDF may extract the SUPI from the second SUCI.

In an example, the UDM may send a Nudm_UEAuthentication_Get response message to the AUSF comprising an indication for the extracted SUPI. For example, the indication may indicate if the SUPI is allowed to have separate security contexts. For example, the indication may be part of a subscription data. For example, the indication may be on different granularity level(s). For example, different granularity levels may refer to the SUPI (associated with the wireless device) being allowed to have separate security contexts per PLMN, multiple registrations in the same PLMN.

For example, multiple registrations in the same PLMN may be in one AMF or in multiple AMF(s). For example, the indication may also indicate not allowed. For example, the indication may indicate a difference between NAS layer and AS layer. For example, the SUPI may be not be allowed to have separate NAS security context(s) and allowed to have separate AS security context(s), and/or the like.

In an example, upon successful completion of the second primary authentication, the AUSF may send a message to the AMF/SEAF comprising a separate security contexts indicator. For example, the message may be a Nausf_UEAuthentication_Authenticate response message.

In an example, in response to running the second primary authentication successfully the AMF and wireless device may activate a second security context. In an example, the AMF may initiate a second NAS SMC procedure. For example, the AMF may send a second NAS security mode command message to the wireless device, wherein the second NAS security command message may comprise an indicator the second security context may be used over the second 3GPP access path. For example, the second security context may comprise one or more key(s), a NAS connection identifier, a NAS COUNT values and/or the like. For example, the key(s) may be at least one of a second K_{AMF}, a second K_{NASint}, a second K_{NASenc} and/or the like. For example, the second security context may be a 5G NAS security context. For example, the second security context may be part of the first 5G security context.

In an example, after the second NAS SMC procedure, the AMF may send a second NGAP Initial context setup message comprising a second K_{gNB} to the second RAN node. For example, the second K_{gNB} may be based on the second Kamf.

In an example, the second RAN node may in response to receiving the second NGAP initial context setup message determine to active AS security. For example, activate AS security may refer to initiating an AS SMC procedure with the wireless device over the second 3GPP access path as described in FIG. 21. Reverting back to FIG. 27 the second RAN node and the wireless device may hold an AS security context 3GPP access path #2 comprising a one or more keys. For example, the one or more keys may comprise a K_{gNB}, a K_{RRCnt}, a K_{RRCenc} and/or the like. For example, the K_{gNB}, the K_{RRCint}, the K_{RRCenc}, and/or the like may be set to one or more first values (e.g., K_{gNB}2, the K_{RRCnt}2, the K_{RRCenc}2) resulting from the second AS SMC. For example, the K_{gNB}² may be the second K_{gNB} and/or the like. For example, the AS security context 3GPP access path #2 may be an AS security context for 3GPP.

In an example, the AMF may send a second registration accept message for the second 3GPP access path via the second RAN node, to the wireless device.

In an example, in response to successfully performing the second primary authentication with the wireless device, the AMF/SEAF may receive the message from the AUSF indicating separate security contexts not allowed.

In an example, the AMF may in response to receiving the message from the AUSF indicating separate security contexts not allowed, send a registration reject message. For example, the reject message may be a NAS message. For example, the message may comprise a cause for rejection. For example, the cause of rejection may be separate security contexts not allowed.

The proposed embodiment may provide signaling to allow the wireless device to have independent security for the first 3GPP access path and the second 3GPP access path.

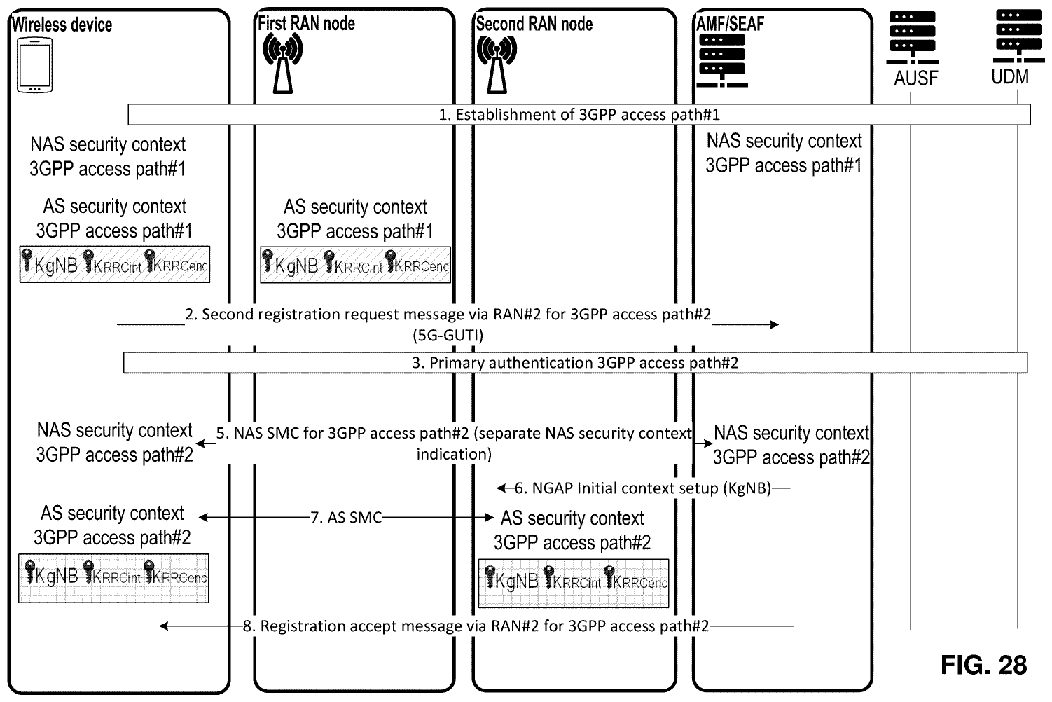

FIG. 28 may depict one example embodiment of the present disclosure. In an example, a wireless device may have one or multiple access paths of an access type established with a network.

In an example, a wireless device and a network may establish a first 3GPP access path (3GPP access path #1) via a first RAN node. For example, establish may refer to the wireless device being registered with the network over the first 3GPP access path. For example, being registered with the network may refer to the wireless device being successfully authenticated by a first primary authentication, the wireless device performing a first NAS SMC procedure with an AMF in the network, the wireless device performing a first AS SMC procedure with the first RAN node, the AMF sending a first K_{gNB} in an NGAP initial context setup message to the first RAN node, the wireless device sending a first registration request message comprising a first SUCI to the network via the first RAN node, the wireless device receiving a first registration accept message from the network via the first RAN node establishing one or more security contexts and/or the like.

For example, a (first) security context may refer to a 5G NAS security context (NAS security context 3GPP access path #1), a common security context, an AS security context for 3GPP access (AS security context 3GPP access path #1), a first 5G security context and/or the like. For example, the AS security context 3GPP access path #1 may comprise a one or more keys. For example, the one or more keys may comprise a K_{gNB}, a K_{RRCint}, a K_{RRCenc} and/or the like. For example, the K_{gNB}, the K_{RRCint}, the K_{RRCenc} and/or the like may be set to one or more first values (e.g., K_{gNB}1, the K_{RRCnt}1, the K_{RRCenc}1) resulting from the first AS SMC. For example, the K_{gNB}1 may be the first K_{gNB}.

In an example, the wireless device may determine to establish a second 3GPP access path (3GPP access path #2). For example, the determining may be based on the need for more bandwidth, support for MA PDU sessions, and/or the like.

In an example, the wireless device may send a second registration request message for the second 3GPP access path via a second RAN node to the AMF, wherein the second registration request message may comprise a 5G-GUTI.

In an example, the AMF may receive the second registration request message from the wireless device. In response to receiving the second registration request message, the AMF may determine to run a second primary authentication over the second access path. For example, the AMF may determine based on a SUPI associated with the 5G-GUTI received in the second registration request message. For example, the AMF may have a policy for the SUPI. For example, the policy may indicate a SUPI with an active connection (first 3GPP access path) may require authentication for the second 3GPP access path and/or the like.

In an example, a SEAF collocated with the AMF may initiate the second primary authentication.

In an example, in response to running the second primary authentication successfully the AMF and wireless device may activate a second security context. In an example, the AMF may initiate a second NAS SMC procedure. For example, the AMF may send a second NAS security mode command message to the wireless device, wherein the second NAS security command message may comprise an indicator the second security context may be used over the second 3GPP access path. For example, the second security context may comprise one or more key(s), a NAS connection identifier, a NAS COUNT values and/or the like. For example, the key(s) may be at least one of a second K_{AMF}, a second K_{NASint}, a second K_{NASenc} and/or the like. For example, the second security context may be a 5G NAS security context. For example, the second security context may be part of the first 5G security context.

In an example, after the second NAS SMC procedure, the AMF may send a second NGAP Initial context setup message comprising a second K_{gNB} to the second RAN node. For example, the second K_{gNB} may be based on the second Kamf.

In an example, the second RAN node may in response to receiving the second NGAP initial context setup message determine to active AS security. For example, activate AS security may refer to initiating a second AS SMC procedure with the wireless device over the second 3GPP access path as described in FIG. 21. Reverting back to FIG. 28 the second RAN node and the wireless device may hold an AS security context 3GPP access path #2. For example, the AS security context 3GPP access path #2 may be an AS security context for 3GPP. For example, the AS security context 3GPP access path #2 may comprise a one or more keys. For example, the one or more keys may comprise a K_{gNB}, a K_{RRCnt}, a K_{RRCenc} and/or the like. For example, the K_{gNB}, the K_{RRCint}, the K_{RRCenc}, and/or the like may be set to one or more first values (e.g., K_{gNB}2, the K_{RRCnt}2, the K_{RRCenc}2) resulting from the second AS SMC. For example, the K_{gNB}2 may be the second K_{gNB}.

In an example, the AMF may send a second registration accept message for the second 3GPP access path via the second RAN node, to the wireless device.

The proposed embodiment may provide signaling to allow the wireless device to have independent security for the first 3GPP access path and the second 3GPP access path.

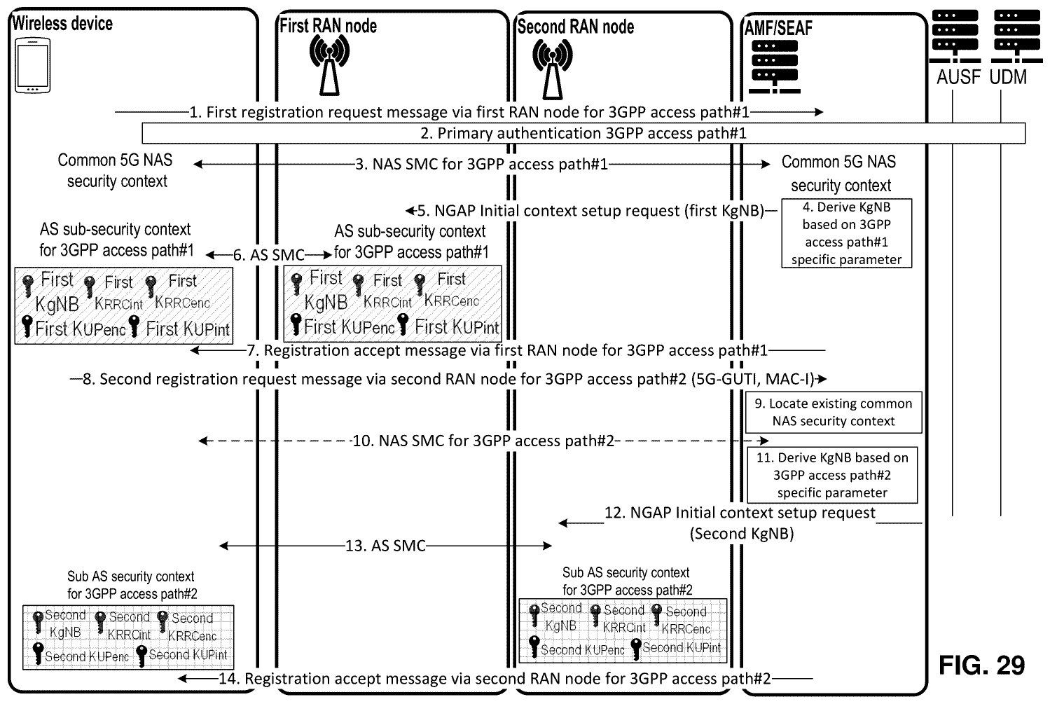

FIG. 29 may depict one example embodiment of the present disclosure. In an example, a wireless device may have one or multiple access paths of an access type established with a network.

In an example, a wireless device may send a first registration request message for a first 3GPP access path (a 3GPP access path #1) via a first RAN node to an AMF. For example, 3GPP access may be a first access type. In an example the first registration request message may be a NAS message. For example, the first registration request message may comprise of an identifier, ngKSI, NAS SQN number and/or the like. For example, the identifier may be at least one of a SUCI, a first 5G-GUTI, and/or the like. In an example, the first registration request message may be an initial NAS message. For example, if the wireless device has a 5G-GUTI, the wireless device may include the 5G-GUTI in the first registration request message.

In an example, the AMF may determine to run a primary authentication. In an example, the AMF may determine to run primary authentication based on receiving the first registration request message. For example, the primary authentication may be initiated by a SEAF.

In an example, in response to the primary authentication, if the primary authentication is successful, the AMF may initiate a first NAS SMC procedure with the wireless device over the first 3GPP access path.

In an example the wireless device and the AMF may have a common security context. In an example, the AMF and the wireless device may have the common security context in response to successfully completing the first NAS SMC procedure. For example, the common security context may be used to protect traffic between the wireless device and the AMF. For example, the common security context may be used by a plurality of 3GPP access path(s). In another example, the common security context may be used by a plurality of non-3GPP access paths.

In an example, the AMF may calculate/derive a first K_{gNB}. For example, calculate/derive may refer to using a key derivation function. For example, a key derivation function may refer to performing logical operations on an input to generate an output. For example, the output may be the first K_{gNB}. For example, logical operations may be AND, OR, XOR, bitshifting and/or the like.

In an example, the first K_{gNB} may be based on the common security context. For example, the first K_{gNB} may be based on a first uplink NAS COUNT, an access type distinguisher, a key, a first access path distinguisher. For example, the first uplink NAS COUNT may be associated with the first 3GPP access path.

For example, the access type distinguisher may indicate 3GPP access, the key may be a Kamf part of the common security context and/or the like.

In an example, the first uplink NAS COUNT may comprise a first padding, a first NAS overflow counter, a first NAS sequence number and/or the like.

In an example, the first access path distinguisher may be a unique value for the first 3GPP access path.

In an example, the access type distinguisher may uniquely identify an access type and an access path. For example, the access type distinguisher may be encoded together with the first access path distinguisher to identify at least one of an access type, access path and/or the like. For example, the encoding may be a two-digit value, where the most significant value uniquely identifies an access path and the least significant bit identifies an access type. For example, the two-digit value may comprise two hexadecimal values.

In an example, the AMF may encode the first access path distinguisher into the padding.

In an example, the first access path distinguisher may be a separate input to the key derivation function.

In an example, the AMF may send the first K_{gNB} to the first RAN node in a first NGAP Initial context setup message. In an example, the AMF may send the first K_{gNB} to the first RAN node in response to deriving the first K_{gNB}.

In an example, the first RAN node may determine to activate AS security with the wireless device. In an example, the first RAN node may determine to activate AS security in response to receiving the first NGAP Initial context setup message. The first RAN node may initiate a first AS SMC procedure with the wireless device via the first 3GPP access path.

In an example, the first RAN node may send a first AS security command message to the wireless device. For example, the first AS security mode command (SMC) message may comprise an indicator, indicating how the wireless device may encode the first access path distinguisher into the calculation of the first K_{gNB} and/or the like.

In an example, the wireless device and the first RAN node may hold an AS—sub-security context for the first 3GPP access path(3GPP access path #1). In an example, the wireless device and the first RAN node may hold the AS sub-security context for the first 3GPP access path in response to completing the first AS SMC procedure For example, from the first RAN node's point of view, the first RAN node may be unaware of the AS sub-security context for the first 3GPP access path is a sub-security context.

For example, the wireless device may be aware the AS sub-security context for the first 3GPP access. For example, aware may refer to the wireless device keeping the AS sub-security context for the first 3GPP access path intact when initiating an AS SMC procedure over a different access path. For example, intact may refer to not replacing keys in the AS sub-security context for the first 3GPP access. For example, the AS—sub-security context for the first 3GPP access path may comprise the first K_{gNB}, a first K_{RRCint}, a first K_{RRCenc}, a first K_{UPint}, a first K_{UPenc} and/or the like.

In an example, the AMF may send a first registration accept message to the wireless device via the first RAN node comprising a 5G-GUTI.

In an example, the wireless device may send a second registration request message for a second 3GPP access path (3GPP access path #2) via the second RAN node. For example, the second registration request message may comprise the 5G-GUTI.

In an example, the AMF may determine the common security context. In an example, the AMF may determine the common security context in response to receiving the second registration request message. For example, determine may refer to locating the common security context. For example, the AMF may locate the common security context based on the 5G-GUTI.

In an example, in response to locating the common security context, the AMF determine to skip a primary authentication of the wireless device over the second 3GPP access path. For example, the AMF may skip the primary authentication and a second NAS SMC procedure if the AMF may successfully verify the integrity of the second registration request message based on the common security context.

In an example, the common security context, may comprise a second uplink NAS COUNT associated with the second 3GPP access path.

In an example, the AMF may derive a second K_{gNB} based on the common security context.

In an example, the second K_{gNB} may be based on the K_{AMF}, a common uplink NAS COUNT, a second access path distinguisher, the access type distinguisher and/or the like. For example, the common uplink NAS COUNT may be used over the first 3GPP access path and the second 3GPP access path. For example, the common uplink NAS COUNT may be associated with a value. For example, the value may be, a start value (0), a latest successful NAS SMC procedure for the wireless device, a latest successful NAS SMC procedure for the wireless device over the second access path and/or the like.

In an example, the second K_{gNB} may be based on the K_{AMF}, the second uplink NAS COUNT, the second access path distinguisher, the access type distinguisher and/or the like.

In an example, the AMF may send the second K_{gNB} to the second RAN node in a second NGAP Initial context setup message.

In an example, the second RAN node may determine to activate AS security with the wireless device. The second RAN node may initiate a second AS SMC procedure with the wireless device via the second 3GPP access path.

In an example, the second RAN node may determine to activate AS security in response (based on) to receiving the second NGAP Initial context setup message,

In an example, the second RAN node may send a second AS security command message to the wireless device. For example, the second AS security mode command message may comprise an indicator, indicating how the wireless device may encode the second access path distinguisher into the calculation of the second K_{gNB} and/or the like.

In an example, the wireless device and the second RAN node may hold an AS—sub-security context for the second 3GPP access path(3GPP access path #2). In an example, the wireless device and the second RAN node may hold the AS sub-security context for the second 3GPP access in response to completing the second AS SMC procedure. For example, hold may refer to the wireless device having a local copy of the AS—sub-security context for the second 3GPP access path and the second RAN node having a local copy of the AS—sub-security context for the second 3GPP access path. For example, the AS—sub-security context for the second 3GPP access path may comprise the second K_{gNB}, a second K_{RRCint}, a second K_{RRCenc}, a second K_{UPint}, a second K_{UPenc} and/or the like.

For example, the wireless device may use the second K_{RRCint} to calculate a message authentication code (MAC) for an RRC message. For example, the wireless device may send the RRC message wherein the RRC message comprises the MAC to the second RAN node (e.g., via the second access path). The second RAN node may in response to receiving the RRC message, verify the integrity of the RRC message based on the second K_{RRCint}.

In an example, the AMF may send a second registration accept message to the wireless device via the second RAN node.

The proposed embodiment may provide signaling to allow the wireless device to handle security for multiple access paths independently.

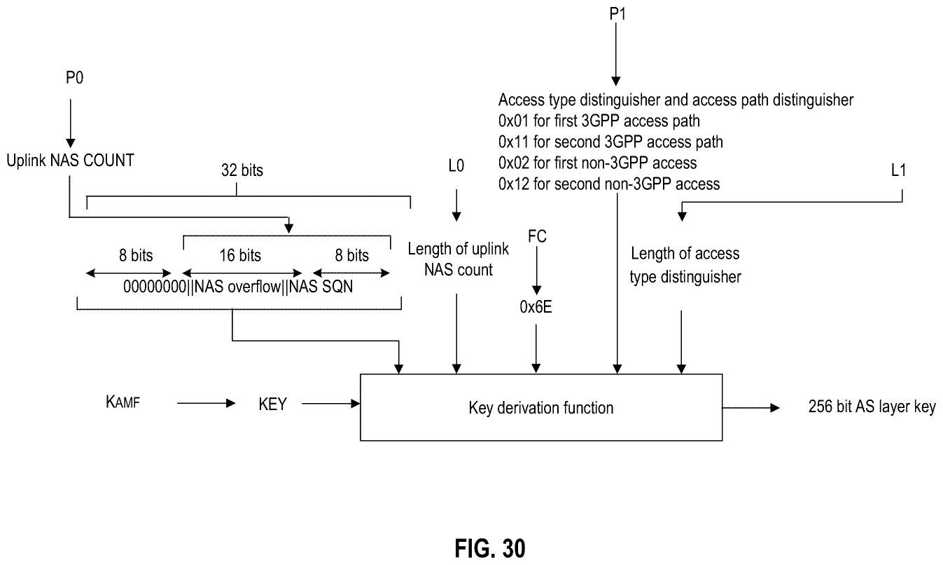

FIG. 30 may depict one example embodiment of the present disclosure. In an example, a key derivation function may produce a key based on an input. For example, the input may be similar to as described in FIG. 19. Reverting back to FIG. 30 the input may be based on an access type distinguisher and an access path distinguisher. For example, the access type distinguisher may determine 3GPP access or non-3GPP access. For example, the access path distinguisher may determine the count of the access path, for example a first access path, a second access path and or/the like

In an example, the access type distinguisher may uniquely identify an access type and an access path. For example, the access type distinguisher may be encoded together with the first access path distinguisher to identify at least one of an access type, access path and/or the like. For example, the encoding may be a two-digit value, where the most significant value uniquely identifies an access path and the least significant bit identifies an access type. For example, the two-digit value may comprise two hexadecimal values.

In an example, the access type distinguisher may be encoded into an uplink NAS COUNT. For example, the uplink NAS COUNT may comprise a padding, a NAS overflow, a NAS SQN and/or the like. For example, the access type distinguisher may be encoded into the padding of the uplink NAS COUNT.

The proposed embodiment may provide means to avoid key collisions when a wireless device is configured with multiple access paths of an access type established with a network.

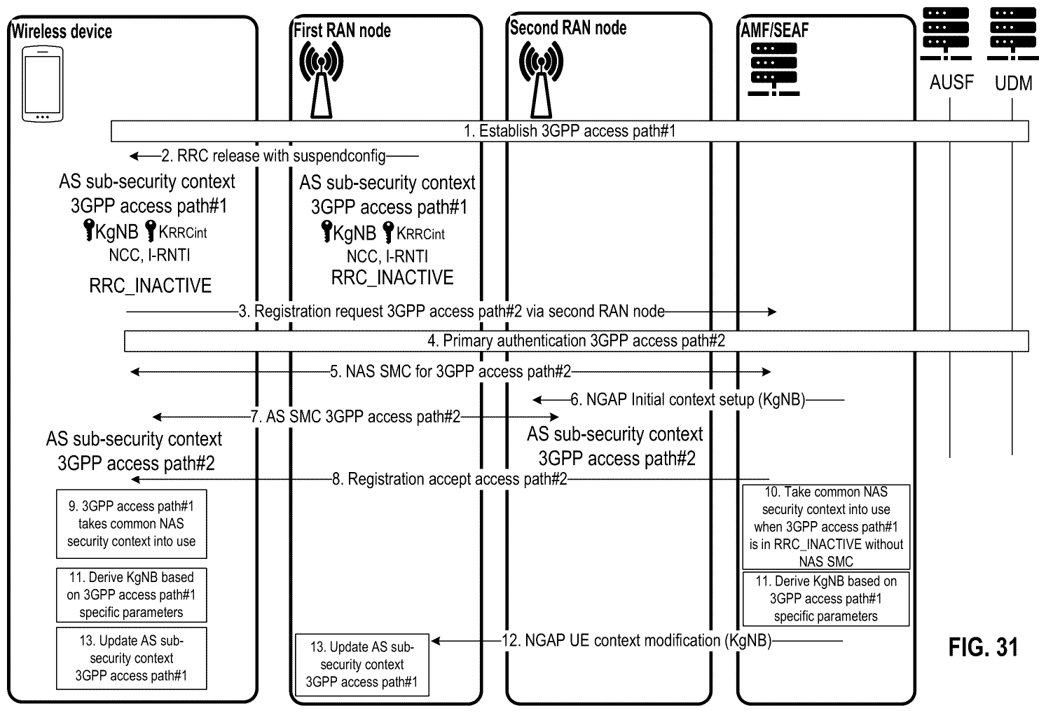

FIG. 31 may depict one example embodiment of the present disclosure.

In an example, a wireless device may have one or multiple access paths of an access type established with a network.

In an example, the wireless device and the network may establish a first 3GPP access path (3GPP access path #1) via a first RAN node. For example, establish may refer to the wireless device being registered with the network over the first 3GPP access path. For example, being registered with the network may refer to the wireless device being successfully authenticated by a first primary authentication, the wireless device performing a first NAS SMC procedure with an AMF in the network, the wireless device performing a first AS SMC procedure with the first RAN node, the AMF sending a first K_{gNB} in an NGAP initial context setup message to the first RAN node, the wireless device sending a first registration request message comprising a first SUCI to the network via the first RAN node, the wireless device receiving a first registration accept message from the network via the first RAN node establishing one or more security contexts and/or the like. For example, a (first) security context may refer to a 5G NAS security context (NAS security context 3GPP access path #1), a common security context, a first AS security context for the first 3GPP access path (AS security context 3GPP access path #1/AS sub-security context 3GPP access path #1), a first 5G security context and/or the like.

In an example, the first RAN node may send a RRCRelease with suspendConfig message to the wireless device. For example, the RRCRelease with suspendConfig message may comprise an I-RNTI, a first NCC and/or the like. The first RAN node may in response to sending the RRCRelease with suspendConfig message to the wireless device start transitioning to RRC_INACTIVE. For example, start transitioning may refer to adjust the first AS security context for the first 3GPP access path. For example, adjust may refer to the behavior described in FIG. 22. Reverting back to FIG. 31.

In an example, the wireless device may start transitioning to RRC_INACTIVE. In an example, the wireless device may start transitioning into RRC_INACTIVE in response to receiving the RRCRelease with suspendConfig message. For example, start transitioning may refer to adjust the first AS security context for the first 3GPP access path. For example, adjust may refer to the behavior described in FIG. 22. Reverting back to FIG. 31 the wireless device and the first RAN node may be in RRC_INACTIVE state for the first 3GPP access path.

In an example, the wireless device may be in RRC_INACTIVE state on the first 3GPP access path and send a registration request for a second 3GPP access path (3GPP access path #2) via a second RAN node to the AMF.

In an example, the AMF may receive the registration request for the second 3GPP access path from the wireless device.

In an example, the AMF may determine to authenticate the wireless device. In an example, the determining may be in response to receiving the registration request for the second 3GPP access path. For example, a SEAF may initiate a primary authentication of the wireless device over the second 3GPP access path.

In an example, in response to completing the primary authentication wherein the primary authentication is successful, the AMF may trigger/perform a second NAS SMC procedure with the wireless device over the second access path. For example, successful may refer to mutual authentication. For example, mutual authentication may refer to the wireless device verifying the identity of the network and the network verifying the identity of the wireless device. For example, the purpose of the second NAS SMC procedure may be to activate a new common security context.

In an example, the second NAS SMC procedure may comprise the AMF sending a NAS security mode command message to the wireless device. For example, the NAS security mode command message may comprise an indication to update the first AS security context for the first 3GPP access path. For example, update may refer to update a K_{gNB} in the first AS security for the first 3GPP access path based on a new K_{AMF} wherein the new K_{AMF} is part of the new common security context. For example, the AMF may include the indication when the first 3GPP access path is in RRC_INACTIVE state and/or the like.

In an example, in response to completing the second NAS SMC procedure the AMF and the wireless device may have activated and/or established the new common security context. For example, activated may refer to currently in use.

In an example, the AMF may derive a new K_{gNB} based on the new common security context for the second access path.

In an example, the AMF may send the new K_{gNB} to the second RAN node in an NGAP Initial context setup message. In an example, the AMF may send the new K_{gNB} in response to deriving the new K_{gNB}.

In an example, the second RAN node may send a second AS security command message to the wireless device.

In an example, the wireless device and the second RAN node may hold an AS sub-security context for the second 3GPP access path (3GPP access path #2) (AS sub-security context 3GPP access path #2). In an example, the wireless device and the second RAN node may hold the AS sub-security context for the second 3GPP access path in response to completing the second AS SMC procedure.

In an example, the AMF may send a second registration accept message to the wireless device via the second RAN node.

In an example, the wireless device may activate the new common security context for the first 3GPP access path. In an example, the wireless device may activate the new common security context in response to receiving the indication to update the first AS security context for the first 3GPP access path.

In an example, the AMF may activate the new common security context for the first 3GPP access path. In an example, the AMF may activate the new common security context for the first 3GPP access path in response to sending the indication to update the first AS security context for the first 3GPP access path. For example, the AMF may activate the new common security context over the first 3GPP access path without a NAS SMC procedure.

In an example, the wireless device may in response to activating the new common security context derive a second new K_{gNB} based on the received indication to update the first AS security context for the first 3GPP access path. For example, the second new K_{gNB} may be based on the new common security context, a specific parameter associated with the first access path and/or the like.

In an example, the wireless device may replace an old K_{gNB} with the second new K_{gNB} in the first AS security context for the first 3GPP access path. In an example, the wireless device may replace the NCC with a new NCC. For example, the new NCC may hold the value zero.

In an example, the AMF may in response to activating the new common security context derive the second new K_{gNB} based on the sent indication to update the first AS security context for the first 3GPP access path and/or the like. For example, the second new K_{gNB} may be based on the new common security context, the specific parameter associated with the first access path and/or the like.

In an example, the AMF may send the second new K_{gNB} to the first RAN node in an NGAP UE context modification request message.

In an example, the first RAN node may replace the old K_{gNB} with the second new K_{gNB} in the first AS security context for the first 3GPP access path. In an example, the first RAN node may replace the old K_{gNB} in response to receiving the NGAP UE context modification request message. In an example, the first RAN node may replace the NCC with the new NCC. For example, the new NCC may hold the value zero.

In an example, the first RAN node may derive a new K_{RRCint} based on the second new K_{gNB} and replace an existing K_{RRCnt} wherein the existing K_{RRCnt} is part of the first AS security context for the first 3GPP access path.

In an example, the wireless device may derive the new K_{RRCnt} and replace the existing K_{RRCnt} wherein the existing K_{RRCnt} is part of the first AS security context for the first 3GPP access path.

The proposed embodiment may provide means to avoid signaling for an access path in RRC_INACTIVE state.

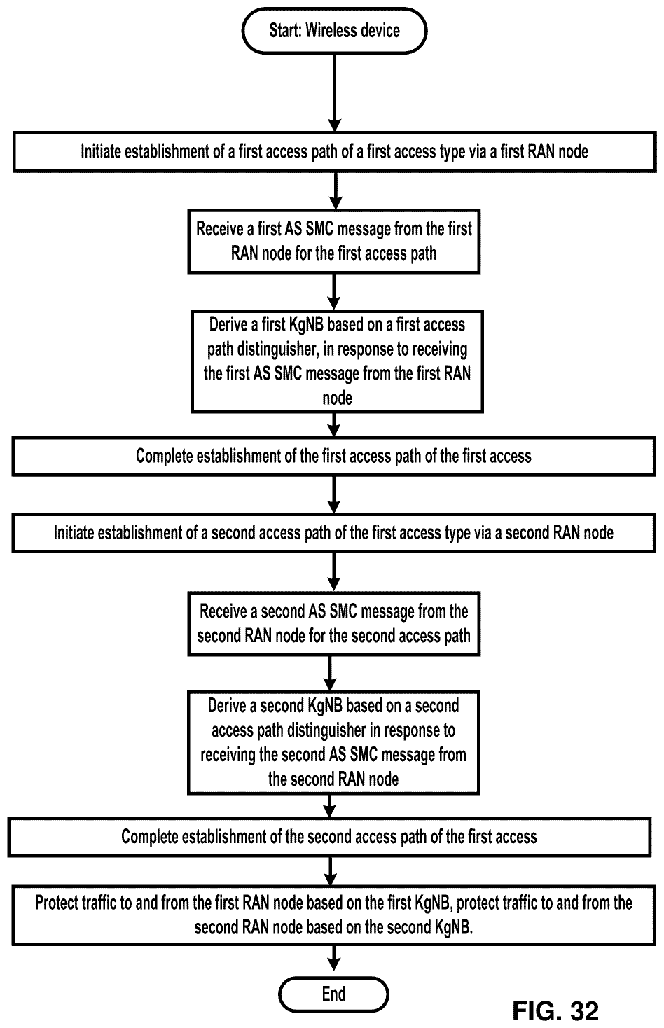

FIG. 32 may illustrate an example flowchart for a wireless device. Similar to the FIG. 29, the wireless device may establish one or multiple 3GPP access paths. For brevity, based on the other part of the present disclosure, redundant details will be omitted.

Reverting back to FIG. 32, the wireless device may initiate establishment of a first access path of a first access type via a first RAN node. For example, initiate may refer to sending a first registration request message to an AMF via the first RAN node. For example, the first registration request message may comprise a first 5G-GUTI, a SUCI and/or the like. For example, the first access type may be 3GPP access.

In an example, the wireless device may in response to initiating the establishment of the first access path receive a first AS SMC message from the first RAN node for the first access path. For example, in response to receiving the first AS SMC message from the first RAN node, the wireless device may derive a first K_{gNB}.

For example, the first K_{gNB} may be based on a first access path distinguisher. In an example, the wireless device may derive a first K_{gNB} associated keys for usage over the first access path. For example, the first K_{gNB} associated keys may refer to a first K_{RRCnt}, a first K_{RRCenc}, a first K_{UPenc}(optional), a first K_{UPint}(optional) and/or the like

In an example, after deriving the first K_{gNB} associated keys, the wireless device may complete establishment of the first access path of the first access type. For example, complete establishment may refer to receiving a first registration accept message via the first RAN node from the AMF. For example, the first registration accept message may comprise a second 5G-GUTI.

In an example, the wireless device may in response to receiving the first registration accept message determine to initiate establishment of a second access path of the first access type via a second RAN node. For example, the determining may be based on a need for higher bandwidth, signal loss (less bandwidth) on the first access path, support of MA PDU sessions and/or the like.

In an example, the wireless device may send a second registration request message for the second access path to the AMF via the second RAN node. For example, the second registration request message may comprise the second 5G-GUTI and/or the like.

In an example, the wireless device may in response to initiating the establishment of the second access path receive a second AS SMC message from the second RAN node for the second access path. For example, in response to receiving the second AS SMC message from the second RAN node, the wireless device may derive a second K_{gNB}.

For example, the second K_{gNB} may be based on a second access path distinguisher. In an example, the wireless device may derive a second K_{gNB} associated keys for usage over the second access path. For example, the second K_{gNB} associated keys may refer to a second K_{RRCnt}, a second K_{RRCenc}, a second K_{UPenc}(optional), a second KUPint(optional) and/or the like.

In an example, after deriving the second K_{gNB} associated keys, the wireless device may complete establishment of the second access path of the first access type. For example, complete establishment may refer to receiving a second registration accept message via the second RAN node from the AMF. For example, the second registration accept message may comprise a third 5G-GUTI.

In an example, in response to establishing the first access path and the second access path of the first access type, the wireless device may exchange data over the first access path and the second access path simultaneously, over the first access path, over the second access path and/or the like.

For example, the wireless device may protect traffic (data) between the wireless device and the first RAN node based on the first K_{gNB} and the first K_{gNB} associated keys.

For example, the wireless device may protect traffic (data) between the wireless device and the second RAN node based on the second K_{gNB} and the second K_{gNB} associated keys and/or the like.

For example, protect may refer to integrity protect and/or cipher. For example, integrity protect may refer to detecting unauthorized altering of data. For example, ciphering may refer to preventing unauthorized reading of data.

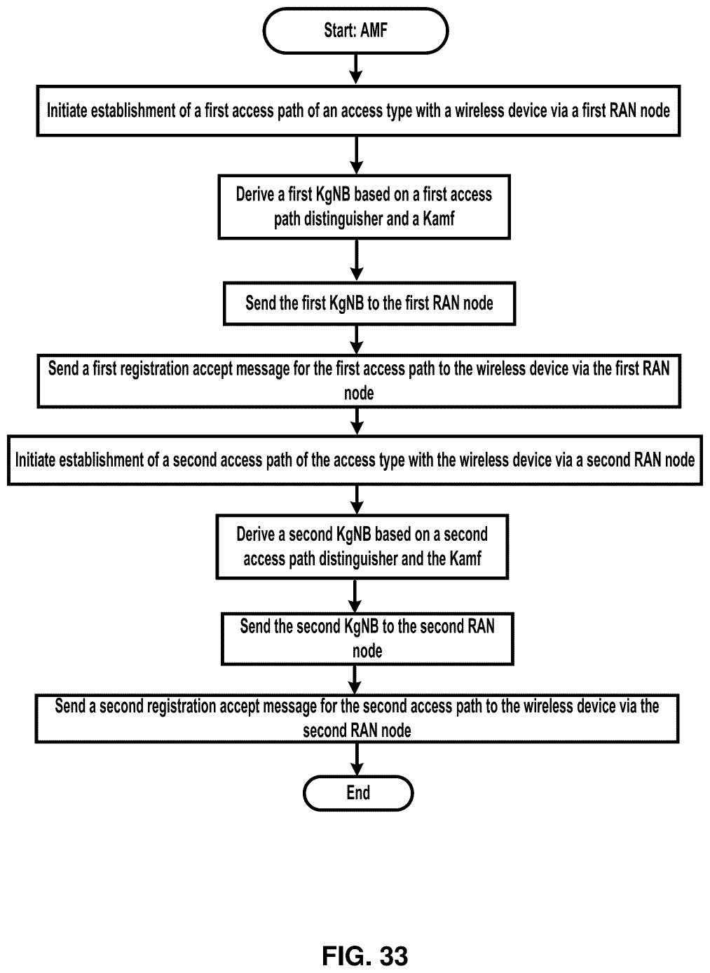

FIG. 33 may illustrate an example flowchart for an AMF. Similar to the FIG. 29, the AMF may establish one or multiple 3GPP access paths with a wireless device. For brevity, based on the other part of the present disclosure, redundant details will be omitted.

Revering back to FIG. 33, the AMF may initiate establishment of a first access path of an access type with a wireless device via a first RAN node.

For example, initiate establishment of the first access path may refer to receiving a first registration request message for the first access path of the access type from the wireless via the first RAN node. For example, the first registration request message may comprise a first 5G-GUTI, a SUCI and/or the like.

In an example, in response to receiving the first registration request from the wireless device the AMF may determine a need to authenticate the wireless device. For example, the need may be based on the AMF not having a valid security context available for the wireless device, the AMF receiving the SUCI in the first registration request message and/or the like.

For example, in response to the AMF determining the need to authenticate the wireless device a SEAF may initiate the authentication. For example, the authentication may be primary authentication.

In an example, in response to completing the authentication, the AMF and the wireless device may active a common security context. For example, active may refer to the AMF initiating a first NAS SMC procedure with the wireless device, the wireless device and the AMF completing the first NAS SMC procedure and/or the like. For example, the common security context may comprise a KAMF.

In an example, in response to completing the first NAS SMC procedure, the AMF may derive a first K_{gNB}. For example, the first K_{gNB} may be based on a first access path distinguisher and the KAMF. For example, the first access path distinguisher may comprise a value unique from other access paths of the access type.

In an example, the AMF may in response to deriving the first K_{gNB}, send the first K_{gNB} to the first RAN node. For example, the AMF may send the first K_{gNB} in a first NGAP initial context setup message. For example, the first NGAP initial context setup message may be a first NGAP initial context setup request message.

In an example, in response to sending the first K_{gNB} to the first RAN node, the AMF may send a first registration accept message to the wireless device for the first access path via the first RAN node. For example, the first registration accept message may comprise a second 5G-GUTI and/or the like.

In an example, the AMF may initiate establishment of a second access path of the access type with the wireless device via a second RAN node.

For example, initiate establishment of the second access path may refer to receiving a second registration request message for the second access path of the access type from the wireless via the second RAN node. For example, the second registration request message may comprise a second 5G-GUTI and/or the like.

In an example, in response to receiving the second registration request from the wireless device the AMF may determine to skip authentication. For example, the determine to skip may be based on the AMF having a valid security context available for the wireless device, and/or the like. For example, the valid security context may be the common security context.

For example, in response to the AMF determining to skip authentication of the wireless device, the AMF and the wireless device may active the common security context over the second access path. For example, active may refer to the AMF initiating a second NAS SMC procedure with the wireless device, the wireless device and the AMF completing the second NAS SMC procedure and/or the like. For example, the common security context may comprise a KAMF.

In an example, in response to completing the second NAS SMC procedure, the AMF may derive a second K_{gNB}. For example, the second K_{gNB} may be based on a second access path distinguisher and the KAMF. For example, the second access path distinguisher may comprise a value unique from other access paths of the access type.

In an example, the AMF may in response to deriving the second K_{gNB}, send the second K_{gNB} to the second RAN node. For example, the AMF may send the second K_{gNB} in a second NGAP initial context setup message. For example, the second NGAP initial context setup message may be a second NGAP initial context setup request message.

In an example, in response to sending the second K_{gNB} to the second RAN node, the AMF may send a second registration accept message to the wireless device for the second access path via the second RAN node.

In an example, the AMF may derive a plurality of K_{gNB}s based on the K_{AMF} part of the common security context. For example, the plurality of K_{gNB}s may be used at different RAN nodes simultaneously. For example, each K_{gNB} of the plurality of K_{gNB}s is unique. For example, unique may mean no K_{gNB} is identical to another K_{gNB}.

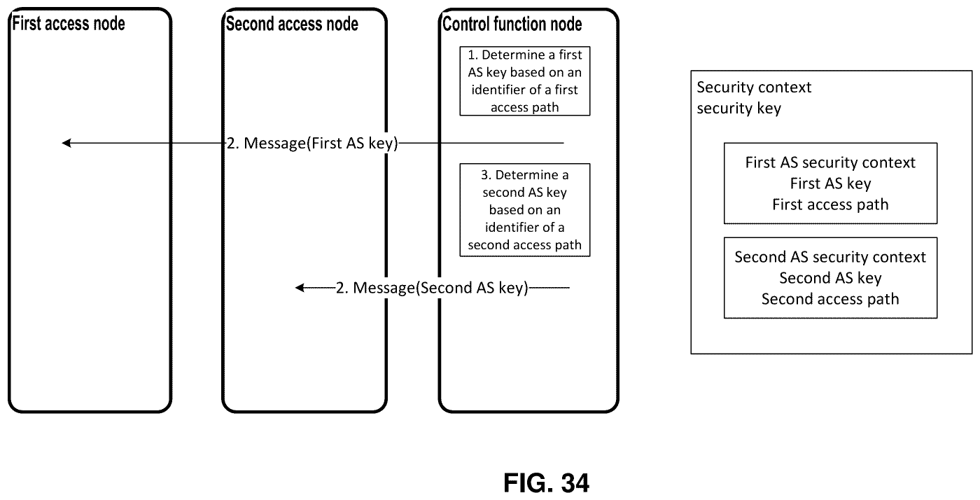

FIG. 34 may depict one example embodiment of the present disclosure. In an example, a control function node may have one or multiple access paths of an access type (a plurality of access paths of the access type) established with a wireless device.

In an example, the control function node may determine a first AS key based on an identifier of a first access path. For example, the identifier of the first access path may be a unique value for the first access path and/or the like. For example, determine the first AS key may refer to using a key derivation function wherein the output may be the first AS security key.

In an example, the control function node may in response to determining the first AS key send the first AS key to a first access node. For example, the control function node may send the first AS key in a first NGAP message. For example, the first NGAP message may be an NGAP initial context setup request message and/or the like.

In an example, the control function node may determine a second AS key based on an identifier of a second access path. For example, the identifier of the second access path may be a unique value for the second access path and/or the like. For example, determine the second AS key may refer to using a key derivation function wherein the output may be the second AS security key.

In an example, the control function node may in response to determining the second AS key send the second AS key to a second access node. For example, the control function node may send the second AS key in a second NGAP message. For example, the second NGAP message may be an NGAP initial context setup request message and/or the like.

In an example, a security context may comprise a security key, a first AS security context, a second AS security context and/or the like. For example, the first AS security context may comprise the first AS key and may be used on the first access path.

For example, the second AS security context may comprise the second AS key and may be used on the second access path. For example, the security context may be a 5G security context. For example, the security key may be a KAMF. For example, the first AS security context may be a first AS security context for 3GPP access and the second AS security context may be a second AS security context for 3GPP access and/or the like. For example, the first AS key may be a first K_{gNB}. For example, the second AS key may be a second K_{gNB}.

In an example, the control function node may be an AMF. In an example, the wireless device may be a UE. In an example, the first access node may be a gNB, a eNB, a ng-eNB and/or the like. In an example, the first access node may be a gNB, a eNB, a ng-eNB and/or the like.

The proposed embodiment may provide signaling to allow the control function node to handle security for multiple access paths independently.

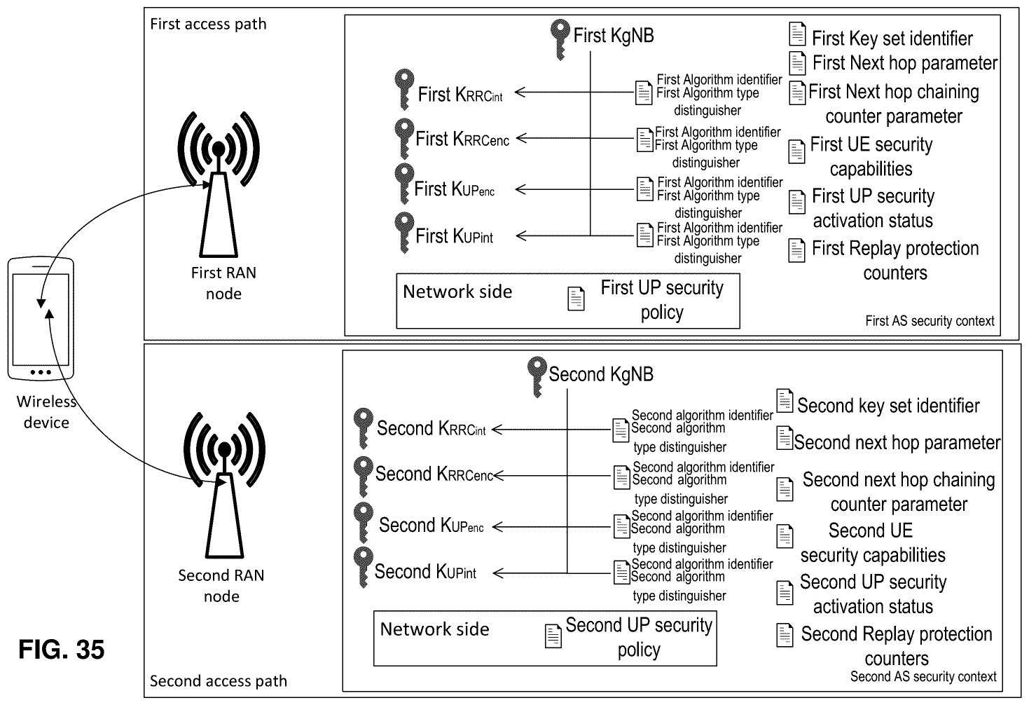

FIG. 35 may depict one example embodiment of the present disclosure. In an example, a wireless device may be configured with multiple access paths of an access type.

In an example, the wireless device may have a first access path established via a first RAN node and a second access path established via a second RAN node and/or the like.

In an example, the wireless device and the first RAN node may hold a first AS security context. For example, hold may refer to the wireless device having the first AS security context available in the wireless device's local memory. For example, hold may refer to the first RAN node having the first AS security context available in the first RAN node's local memory.

In an example, the wireless device and the first RAN node may use the first AS security context to protect traffic between the first RAN node and the wireless device. For example, use may refer to using a key in the first AS security context to protect traffic between the wireless device and the first RAN node. For example, using a key may refer to calculating a MAC, ciphering, deciphering, verifying a MAC and/or the like.

In an example, the wireless device and the second RAN node may hold a second AS security context. For example, hold may refer to the wireless device having the second AS security context available in the wireless device's local memory. For example, hold may refer to the second RAN node having the second AS security context available in the second RAN node's local memory.

In an example, the wireless device and the second RAN node may use the second AS security context to protect traffic between the second RAN node and the wireless device. For example, use may refer to using a key in the second AS security context to protect traffic between the wireless device and the second RAN node. For example, using a key may refer to calculating a MAC, ciphering, deciphering, verifying a MAC and/or the like.

In an example, the wireless may hold the first AS security context and the second AS security context simultaneously. For example, the wireless device may determine to use the first AS security context with the first RAN node and the second AS security context with the second RAN node. For example, determine may refer to associating a first cell-radio network temporary identifier (C-RNTI) with the first AS security context/first RAN node and a second C-RNTI for the second AS security context/second RAN node and/or the like.

In an example, the wireless device may have parameters common for the first access path and the second access path. For example, a common parameter(s) may be UE security capabilities, algorithm identifier(s), algorithm type distinguisher(s) and/or the like. For example, a common AS security context may comprise the common parameter(s), the first AS security context, the second AS security context and/or the like. For example, the first AS security context and the second AS security context may be AS sub-security contexts.

In an example, a wireless device may send a first registration request message via a first RAN node to an AMF. For example, the first registration request message may request a first access path of an access type. For example, the access type may be 3GPP access, non-3GPP access and/or the like. For example, the first registration request message may comprise a first 5G-GUTI, a SUCI and/or the like.

In an example, the AMF may determine to authenticate the wireless device. In an example, the determining may be in response to receiving the first registration request message from the wireless device via the first RAN node. For example, the determining may be based on the AMF not having a valid security context for the wireless device, the first registration request comprising the SUCI, an operator policy, an AMF policy and/or the like. For example, authentication may refer to a first primary authentication. For example, the first primary authentication may apply to the first access path. For example, the first primary authentication may be initiated by a SEAF.

In an example, in response to completing the first primary authentication successfully, the AMF and the wireless device may have a partial security context available.

In an example, the AMF may initiate a first NAS SMC procedure with the wireless device. In an example, the initiation of the first NAS SMC may be based on the wireless device and the AMF having the partial security context available. For example, initiate may refer to sending a first NAS security mode command (SMC) message to the wireless device via the first RAN node. For example, upon completing the first NAS SMC procedure via the first RAN node the AMF and the wireless device may determine a common security context. For example, determine the common security context may refer to transitioning the partial security context into the common security context. For example, transitioning may refer to activating/taking into use and/or deriving one or more keys. For example, the common security context may comprise a K_{AMF}, a K_{NASint}, a K_{NAsenc}, NAS COUNT(s) and/or the like.

In an example, the AMF may derive a first AS key. For example, the first AS key may be a first NH, a first K_{gNB} and/or the like. In an example, the AMF may derive the first AS key in response to completing the first NAS SMC procedure. For example, the first K_{gNB} may be based on a value associated with the first access path and the common security context. For example, the value associated with the first access path may be a first access path distinguisher. For example, the value associated with the first access path may be a value identifying the first access path. For example, the value associated with the first access path may be encoded together with an access type distinguisher. For example, the access type distinguisher may represent 3GPP, non-3GPP and/or the like. For example, the first K_{gNB} may be based on the K_{AMF}.

For example, derive may refer to using a key derivation function wherein a first input to the key derivation function may generate a first output. For example, the first output may be the first K_{gNB} and/or the like.

In an example, the AMF may send the first K_{gNB} to the first RAN node. For example, the AMF may send the first K_{gNB} in a first NGAP Initial context setup request message and/or the like. In an example, the AMF may send the first K_{gNB} to the first RAN node in response to deriving the first K_{gNB}

In an example, the first RAN node may initiate a first AS SMC procedure with the wireless device. In an example, the first RAN node may initiate the first AS SMC in response to receiving the first NGAP Initial context setup request message. For example, initiate may refer to sending a first AS security mode command (SMC) message to the wireless device via the first access path.

In an example, the wireless device and the first RAN node may hold a first AS security context. In an example, the holding of the AS security context may be in response to completing the first AS SMC procedure. For example, the first AS security context may comprise the first K_{gNB}, a first ciphering key for RRC, a first integrity key for RRC, a first integrity key for UP, a first ciphering key for UP and/or the like. For example, the first integrity key for RRC may be a first K_{RRCnt}, the first ciphering key for RRC may be a first K_{RRCenc}, the first integrity key for UP may be a first K_{UPint}, the first ciphering key for UP may be a first K_{UPenc} and/or the like.

For example, the first AS security context may be associated with the first access path. For example, the first AS security context may be used by the first RAN node and the wireless device to protect traffic (data) over the first access path.

In an example, the first AS security context may be a first AS-sub-security context, a first AS security context for 3GPP access and/or the like.

In an example, the AMF may send a first registration accept message for the first access path via the first RAN node. In an example, the sending of the first registration accept message may be in response to sending the first K_{gNB} to the first RAN node. For example, the first registration accept message may comprise a second 5G-GUTI and/or the like.

In an example, the wireless device may determine to establish a second access path of the access type. In an example, the wireless device may determine to establish the second access path in response to receiving the first registration accept message. For example, the determining may be based on the wireless device supporting MA PDU session(s), signal loss (less bandwidth available) on the first access path, need for more bandwidth and/or the like.

In an example, the wireless device may send a second registration request message to the AMF via a second RAN node. For example, the second registration request may request the second access path of the access type. For example, the second registration request message may comprise the second 5G-GUTI and/or the like.

In an example, the AMF may receive the second registration request message from the wireless device via the second RAN node.

In an example, the AMF may in response to receiving the second registration request message from the wireless device locate the common security context. For example, locate may refer to using the second 5G-GUTI. For example, the second 5G-GUTI may be associated with the common security context. For example, the AMF may search locally within the AMF's memory based on the 5G-GUTI and/or the like.

In an example, the AMF may verify the integrity of the second registration request message based on the common security context and/or the like. In an example, the verification of integrity may be in response to locating the common security context.

For example, the AMF may calculate an expected message authentication code (MAC) and compare with the MAC-I from the second registration request message and/or the like.

For example, if the MAC-I from the second registration request message and the expected MAC are identical the integrity may be verified. For example, verified may refer to the second registration request message not being altered by an unauthorized party.

In an example, the AMF may derive a second AS key. In an example, the AMF may derive the second AS key in response to verifying the integrity of the second registration request message based on the common security context. For example, the second AS key may be a second NH, a second K_{gNB} and/or the like.

For example, the second K_{gNB} may be based on a value associated with the second access path and the common security context. For example, the value associated with the second access path may be a second access path distinguisher. For example, the value associated with the second access path may be a value identifying the second access path. For example, the value associated with the second access path may be encoded together with the access type distinguisher. For example, the access type distinguisher may represent 3GPP, non-3GPP and/or the like. For example, the second K_{gNB} may be based on the K_{AMF}.

For example, derive may refer to using the key derivation function wherein a second input to the key derivation function may generate a second output. For example, the second output may be the second K_{gNB} and/or the like.

In an example, the AMF may send the second K_{gNB} to the second RAN node. In an example, the AMF may send the second K_{gNB} in response to deriving the second K_{gNB}. For example, the AMF may send the second K_{gNB} in a second NGAP Initial context setup request message and/or the like.

In an example, the second RAN node may initiate a second AS SMC procedure with the wireless device. In an example, the second RAN node may initiate the second AS SMC in response to receiving the second NGAP Initial context setup request message. For example, initiate may refer to sending a second AS security mode command message to the wireless device via the second access path.

In an example, the wireless device and the second RAN node may hold a second AS security context. In an example, the wireless device and the second RAN node may hold the second AS security context in response to completing the second AS SMC procedure. For example, the second AS security context may comprise the second K_{gNB}, a second ciphering key for RRC, a second integrity key for RRC, a second integrity key for UP, a second ciphering key for UP and/or the like. For example, the second integrity key for RRC may be a second K_{RRCint}, the second ciphering key for RRC may be a second K_{RRCenc} the second key for UP may be a second K_{UPint}, the second ciphering key for UP may be a second K_{UPenc} and/or the like.

For example, the second AS security context may be associated with the second access path. For example, the second AS security context may be used by the second RAN node and the wireless device to protect traffic (data) over the second access path.

In an example, the second AS security context may be a second AS-sub-security context, a second AS security context for 3GPP access and/or the like.

In an example, the AMF may send a second registration accept message for the second access path via the second RAN node. In an example, the AMF may send the second registration accept message in response to sending the second K_{gNB} to the second RAN node. For example, the second registration accept message may comprise a third 5G-GUTI and/or the like.

In an example, a 5G security context may comprise the first AS security context associated with the first access path for the access type, the second AS security context associated with the second access path for the access type, the common security context and/or the like.

In an example, the first RAN node and the second RAN node may be replaced with a first N3IWF and a second N3IWF and/or the like. For example, the first N3IWF may hold a first AS security context for non-3GPP access and the second N3IWF may hold a second AS security context for non-3GPP access and/or the like. For example, the first AS security context for non 3GPP access may be associated with a first non-3GPP access path and the second AS security context for non-3GPP access may be associated with a second non-3GPP access path. For example, the first AS security context for non-3GPP access and the second AS security context for non 3GPP access may be based on the common security context.

1. A method comprising:
receiving, by an access and mobility management function (AMF) from a wireless device, a first registration request message for a first access path of an access type via a first access node;
determining, by the AMF, a common security context for the wireless device;
sending, by the AMF to the first access node, a first access stratum (AS) key, wherein the first AS key is based on a first value associated with the first access path and the common security context;
receiving, by the AMF from the wireless device a second registration request message for a second access path of the access type via a second access node; and
sending, by the AMF to the second access node, a second AS key, wherein the second AS key is based on a second value associated with the second access path and the common security context.

2. The method of claim 1, wherein one or both of the first value and the second value are based on an encoding of:
an access type distinguisher
a value identifying the first access path.

3. The method of claim 1, wherein the first value and the second value are part of the common security context.

4. The method of claim 1, wherein the common security context comprises a non-access stratum key.

5. The method of claim 1, wherein the first AS key is associated with the first access path of the access type and the second AS key is associated with the second access path of the access type.

6. The method of claim 1, wherein the first AS key is part of a first AS security context associated with the first access path of the access type and the second AS key is part of a second AS security context associated with the second access path of the access type.

7. The method of claim 1, wherein the first AS security context is associated with the first access node and the second AS security context is associated with the second access node.

8. An access and mobility management function (AMF) comprising one or more processors and memory storing instructions that, when executed by the one or more processors, cause the AMF to:
receive, from a wireless device, a first registration request message for a first access path of an access type via a first access node;
determine a common security context for the wireless device;
send, to the first access node, a first access stratum (AS) key, wherein the first AS key is based on a first value associated with the first access path and the common security context;
receive, from the wireless device a second registration request message for a second access path of the access type via a second access node; and
send, to the second access node, a second AS key, wherein the second AS key is based on a second value associated with the second access path and the common security context.

9. The AMF of claim 8, wherein one or both of the first value and the second value are based on an encoding of:
an access type distinguisher
a value identifying the first access path.

10. The AMF of claim 8, wherein the first value and the second value are part of the common security context.

11. The AMF of claim 8, wherein the common security context comprises a non-access stratum key.

12. The AMF of claim 8, wherein the first AS key is associated with the first access path of the access type and the second AS key is associated with the second access path of the access type.

13. The AMF of claim 8, wherein the first AS key is part of a first AS security context associated with the first access path of the access type and the second AS key is part of a second AS security context associated with the second access path of the access type.

14. The AMF of claim 8, wherein the first AS security context is associated with the first access node and the second AS security context is associated with the second access node.

15. A non-transitory computer-readable medium comprising instructions that, when executed by one or more processors, cause an access and mobility management function (AMF) to:
receive, from a wireless device, a first registration request message for a first access path of an access type via a first access node;
determine a common security context for the wireless device;
send, to the first access node, a first access stratum (AS) key, wherein the first AS key is based on a first value associated with the first access path and the common security context;
receive, from the wireless device a second registration request message for a second access path of the access type via a second access node; and
send, to the second access node, a second AS key, wherein the second AS key is based on a second value associated with the second access path and the common security context.

16. The non-transitory computer-readable medium of claim 15, wherein one or both of the first value and the second value are based on an encoding of:
an access type distinguisher
a value identifying the first access path.

17. The non-transitory computer-readable medium of claim 15, wherein the first value and the second value are part of the common security context.

18. The non-transitory computer-readable medium of claim 15, wherein the common security context comprises a non-access stratum key.

19. The non-transitory computer-readable medium of claim 15, wherein the first AS key is associated with the first access path of the access type and the second AS key is associated with the second access path of the access type.

20. The non-transitory computer-readable medium of claim 15, wherein the first AS key is part of a first AS security context associated with the first access path of the access type and the second AS key is part of a second AS security context associated with the second access path of the access type.
